(19) United States
(12) Patent Application Publication
(10) Pub. No.: US 2024/0324063 A1
(43) Pub. Date: Sep. 26, 2024

(54) NETWORK NODE DISCONTINUOUS RECEPTION AND TRANSMISSION

(71) Applicant: QUALCOMM Incorporated, San Diego, CA (US)

(72) Inventors: Navid ABEDINI, Basking Ridge, NJ (US); Jianghong LUO, Skillman, NJ (US); Hung Dinh LY, San Diego, CA (US); Jelena DAMNJANOVIC, Del Mar, CA (US); Tao LUO, San Diego, CA (US); Sherif ELAZZOUNI, San Diego, CA (US)

(21) Appl. No.: 18/613,968

(22) Filed: Mar. 22, 2024

Related U.S. Application Data
(60) Provisional application No. 63/492,132, filed on Mar. 24, 2023.

(51) Int. Cl. H04W 76/28; H04L 1/1812; H04W 72/1273

(52) U.S. Cl. CPC H04W 76/28; H04L 1/1812; H04W 72/1273

(57) ABSTRACT

Various aspects of the present disclosure generally relate to wireless communication. In some aspects, a user equipment (UE) may receive an offset for a discontinuous reception (DRX) or discontinuous transmission (DTX) cycle of a network node, the offset being based at least in part on a connected mode DRX or DTX cycle of the UE. The UE may communicate with the network node in accordance with the DRX or DTX cycle of the network node and the offset for the DRX or DTX cycle of the network node. Numerous other aspects are described.

### CROSS-REFERENCE TO RELATED APPLICATION

This patent application claims priority to U.S. Provisional Patent Application No. 63/492,132, filed on Mar. 24, 2023, titled “NETWORK NODE DISCONTINUOUS RECEPTION AND TRANSMISSION,” and assigned to the assignee hereof. The disclosure of the prior application is considered part of and is incorporated by reference into this patent application.

### FIELD OF THE DISCLOSURE

Aspects of the present disclosure generally relate to wireless communication and to techniques and apparatuses for network node discontinuous reception and transmission.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include receiving an offset for a discontinuous reception (DRX) or discontinuous transmission (DTX) cycle of a network node, the offset being based at least in part on a connected mode DRX or DTX cycle of the UE. The method may include communicating with the network node in accordance with the DRX or DTX cycle of the network node and the offset for the DRX or DTX cycle of the network node.

Some aspects described herein relate to a method of wireless communication performed by a network node. The method may include identifying, based at least in part on a connected mode DRX or DTX cycle of a UE, an offset for a DRX or DTX cycle of the network node. The method may include communicating with the UE in accordance with the DRX or DTX cycle of the network node and the offset for the DRX or DTX cycle of the network node.

Some aspects described herein relate to a method of wireless communication performed by a UE. The method may include receiving an indication of a DRX or DTX cycle of a network node. The method may include communicating with the network node based at least in part on switching between a connected mode DRX or DTX cycle of the UE and the DRX or DTX cycle of the network node.

Some aspects described herein relate to a method of wireless communication performed by a network node. The method may include transmitting an indication of a DRX or DTX cycle of the network node. The method may include communicating with a UE based at least in part on switching between a connected mode DRX or DTX cycle of the UE and the DRX or DTX cycle of the network node.

Some aspects described herein relate to an apparatus for wireless communication at a UE. The apparatus may include a memory and one or more processors coupled to the memory. The one or more processors may be configured to receive an offset for a DRX or DTX cycle of a network node, the offset being based at least in part on a connected mode DRX or DTX cycle of the UE. The one or more processors may be configured to communicate with the network node in accordance with the DRX or DTX cycle of the network node and the offset for the DRX or DTX cycle of the network node.

Some aspects described herein relate to an apparatus for wireless communication at a network node. The apparatus may include a memory and one or more processors coupled to the memory. The one or more processors may be configured to identify, based at least in part on a connected mode DRX or DTX cycle of a UE, an offset for a DRX or DTX cycle of the network node. The one or more processors may be configured to communicate with the UE in accordance with the DRX or DTX cycle of the network node and the offset for the DRX or DTX cycle of the network node.

Some aspects described herein relate to an apparatus for wireless communication at a UE. The apparatus may include a memory and one or more processors coupled to the memory. The one or more processors may be configured to receive an indication of a DRX or DTX cycle of a network node. The one or more processors may be configured to communicate with the network node based at least in part on switching between a connected mode DRX or DTX cycle of the UE and the DRX or DTX cycle of the network node.

Some aspects described herein relate to an apparatus for wireless communication at a network node. The apparatus may include a memory and one or more processors coupled to the memory. The one or more processors may be configured to transmit an indication of a DRX or DTX cycle of the network node. The one or more processors may be configured to communicate with a UE based at least in part on switching between a connected mode DRX or DTX cycle of the UE and the DRX or DTX cycle of the network node.

Some aspects described herein relate to a non-transitory computer-readable medium that stores a set of instructions for wireless communication by a UE. The set of instructions, when executed by one or more processors of the UE, may cause the UE to receive an offset for a DRX or DTX cycle of a network node, the offset being based at least in part on a connected mode DRX or DTX cycle of the UE. The set of instructions, when executed by one or more processors of the UE, may cause the UE to communicate with the network node in accordance with the DRX or DTX cycle of the network node and the offset for the DRX or DTX cycle of the network node.

Some aspects described herein relate to a non-transitory computer-readable medium that stores a set of instructions for wireless communication by a network node. The set of instructions, when executed by one or more processors of the network node, may cause the network node to identify, based at least in part on a connected mode DRX or DTX cycle of a UE, an offset for a DRX or DTX cycle of the network node. The set of instructions, when executed by one or more processors of the network node, may cause the network node to communicate with the UE in accordance with the DRX or DTX cycle of the network node and the offset for the DRX or DTX cycle of the network node.

Some aspects described herein relate to a non-transitory computer-readable medium that stores a set of instructions for wireless communication by a UE. The set of instructions, when executed by one or more processors of the UE, may cause the UE to receive an indication of a DRX or DTX cycle of a network node. The set of instructions, when executed by one or more processors of the UE, may cause the UE to communicate with the network node based at least in part on switching between a connected mode DRX or DTX cycle of the UE and the DRX or DTX cycle of the network node.

Some aspects described herein relate to a non-transitory computer-readable medium that stores a set of instructions for wireless communication by a network node. The set of instructions, when executed by one or more processors of the network node, may cause the network node to transmit an indication of a DRX or DTX cycle of the network node. The set of instructions, when executed by one or more processors of the network node, may cause the network node to communicate with a UE based at least in part on switching between a connected mode DRX or DTX cycle of the UE and the DRX or DTX cycle of the network node.

Some aspects described herein relate to an apparatus for wireless communication. The apparatus may include means for receiving an offset for a DRX or DTX cycle of a network node, the offset being based at least in part on a connected mode DRX or DTX cycle of the apparatus. The apparatus may include means for communicating with the network node in accordance with the DRX or DTX cycle of the network node and the offset for the DRX or DTX cycle of the network node.

Some aspects described herein relate to an apparatus for wireless communication. The apparatus may include means for identifying, based at least in part on a connected mode DRX or DTX cycle of a UE, an offset for a DRX or DTX cycle of the apparatus. The apparatus may include means for communicating with the UE in accordance with the DRX or DTX cycle of the apparatus and the offset for the DRX or DTX cycle of the apparatus.

Some aspects described herein relate to an apparatus for wireless communication. The apparatus may include means for receiving an indication of a DRX or DTX cycle of a network node. The apparatus may include means for communicating with the network node based at least in part on switching between a connected mode DRX or DTX cycle of the apparatus and the DRX or DTX cycle of the network node.

Some aspects described herein relate to an apparatus for wireless communication. The apparatus may include means for transmitting an indication of a DRX or DTX cycle of the apparatus. The apparatus may include means for communicating with a UE based at least in part on switching between a connected mode DRX or DTX cycle of the UE and the DRX or DTX cycle of the apparatus.

Aspects generally include a method, apparatus, system, computer program product, non-transitory computer-readable medium, UE, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of a discontinuous reception (DRX) configuration, in accordance with the present disclosure.

FIG. 5 is a diagram illustrating an example of network node DRX and discontinuous transmission (DTX), in accordance with the present disclosure.

FIGS. 6A-6B are diagrams illustrating examples of parameters for network node DRX and DTX, in accordance with the present disclosure.

FIGS. 7A-7B are diagrams illustrating examples of DRX and DTX timers, in accordance with the present disclosure.

FIG. 8 is a diagram illustrating an example of network node DRX and DTX, in accordance with the present disclosure.

FIG. 9 is a diagram illustrating examples of DRX and DTX configuration switching, in accordance with the present disclosure.

FIG. 10 is a diagram illustrating an example process performed, for example, by a UE, in accordance with the present disclosure.

FIG. 11 is a diagram illustrating an example process performed, for example, by a network node, in accordance with the present disclosure.

FIG. 12 is a diagram illustrating an example process performed, for example, by a UE, in accordance with the present disclosure.

FIG. 13 is a diagram illustrating an example process performed, for example, by a network node, in accordance with the present disclosure.

FIG. 14 is a diagram of an example apparatus for wireless communication, in accordance with the present disclosure.

FIG. 15 is a diagram of an example apparatus for wireless communication, in accordance with the present disclosure.

### DETAILED DESCRIPTION

A discontinuous reception (DRX) or discontinuous transmission (DTX) configuration for a user equipment (UE) may enable the UE to conserve battery power and to reduce power consumption by entering a sleep state when the UE is not communicating with a network node. In some cases, the network node may not be configured with a DRX or DTX configuration. For example, the network node may be in an active state for an extended period of time, such as an indefinite period of time. Alternatively, the network node may operate in accordance with a DRX or DTX configuration that does not align with a connected mode DRX or DTX configuration of the UE. For example, a DRX or DTX cycle of the network node may be in an active state while the connected mode DRX or DTX configuration of the UE is in an inactive state. This may result in wasted energy and processing resources by the network node.

Techniques and apparatuses are described herein for network node DRX and DTX. In some aspects, a network node may identify information associated with a DRX or DTX cycle of the network node. For example, the network node may identify at least one of an offset, a duration, or a periodicity associated with the DRX or DTX cycle of the network node. The information for the DRX or DTX cycle of the network node may be based at least in part on a connected mode DRX or DTX cycle of a UE. The UE may receive the information associated with the DRX or DTX cycle of the network node, and the UE and the network node may communicate in accordance with the DRX or DTX cycle of the network node and the information associated with the DRX or DTX cycle of the network node. This may enable the DRX or DTX cycle of the network node to be aligned with the connected mode DRX or DTX cycle of the UE. For example, the network node may enter an inactive period of the DRX or DTX cycle of the network node during an inactive period of the connected mode DRX or DTX cycle of the UE. In some aspects, the UE and/or the network node may switch between the DRX or DTX cycle of the network node and the connected mode DRX or DTX cycle of the UE. In some aspects, the DRX or DTX cycle of the network node may introduce additional downlink or uplink restrictions in addition to the restrictions imposed by the connected mode DRX or DTX cycle of the UE. Additionally, the DRX or DTX configuration of the network node may be dynamically adaptable. The DRX or DTX cycle of the network node may be aligned with the connected mode DRX or DTX cycle of the UE without requiring synchronization signal block (SSB) changes and without impacting UEs in an idle or inactive mode. By operating in this manner, the network node may conserve energy and processing resources based at least in part on being aligned with the connected mode DRX or DTX cycle of the UE. Additional details are described herein.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

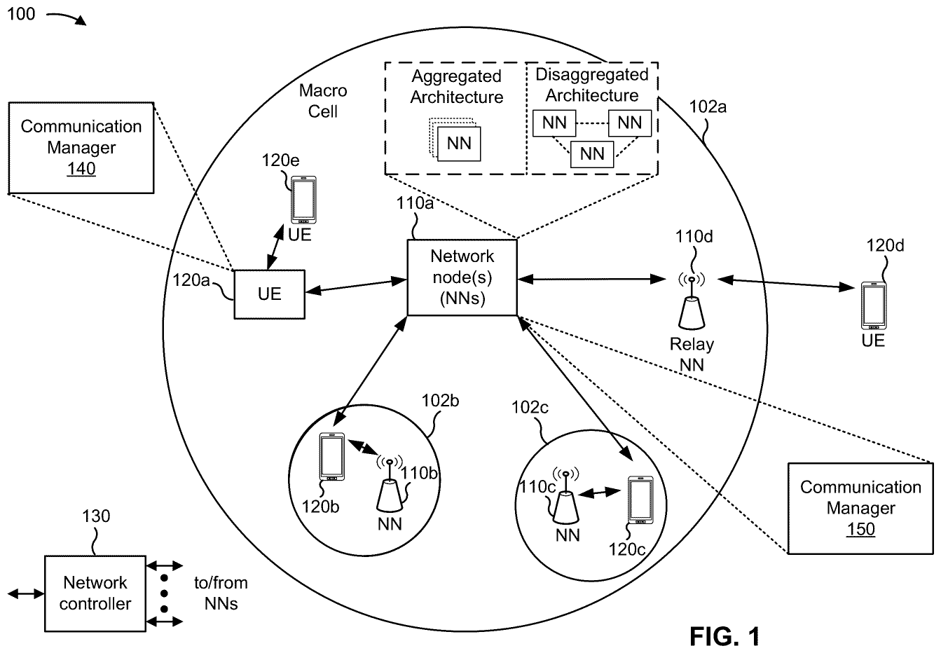

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120c), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an cNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (cMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120c) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHZ) and FR2 (24.25 GHz-52.6 GHz). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHZ-71 GHz), FR4 (52.6 GHZ-114.25 GHZ), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive an offset for a DRX or DTX cycle of a network node, the offset being based at least in part on a connected mode DRX or DTX cycle of the UE; and communicate with the network node in accordance with the DRX or DTX cycle of the network node and the offset for the DRX or DTX cycle of the network node.

In some aspects, the communication manager 140 may receive an indication of a DRX or DTX cycle of a network node; and communicate with the network node based at least in part on switching between a connected mode DRX or DTX cycle of the UE and the DRX or DTX cycle of the network node. Additionally, or alternatively, the communication manager 140 may perform one or more other operations described herein.

In some aspects, the network node 110 may include a communication manager 150. As described in more detail elsewhere herein, the communication manager 150 may identify, based at least in part on a connected mode DRX or DTX cycle of a UE, an offset for a DRX or DTX cycle of the network node; and communicate with the UE in accordance with the DRX or DTX cycle of the network node and the offset for the DRX or DTX cycle of the network node.

In some aspects, the communication manager 150 may transmit an indication of a DRX or DTX cycle of the network node; and communicate with a UE based at least in part on switching between a connected mode DRX or DTX cycle of the UE and the DRX or DTX cycle of the network node. Additionally, or alternatively, the communication manager 150 may perform one or more other operations described herein.

As indicated above, FIG. 1 is provided as an example. Other examples may differ from what is described with regard to FIG. 1.

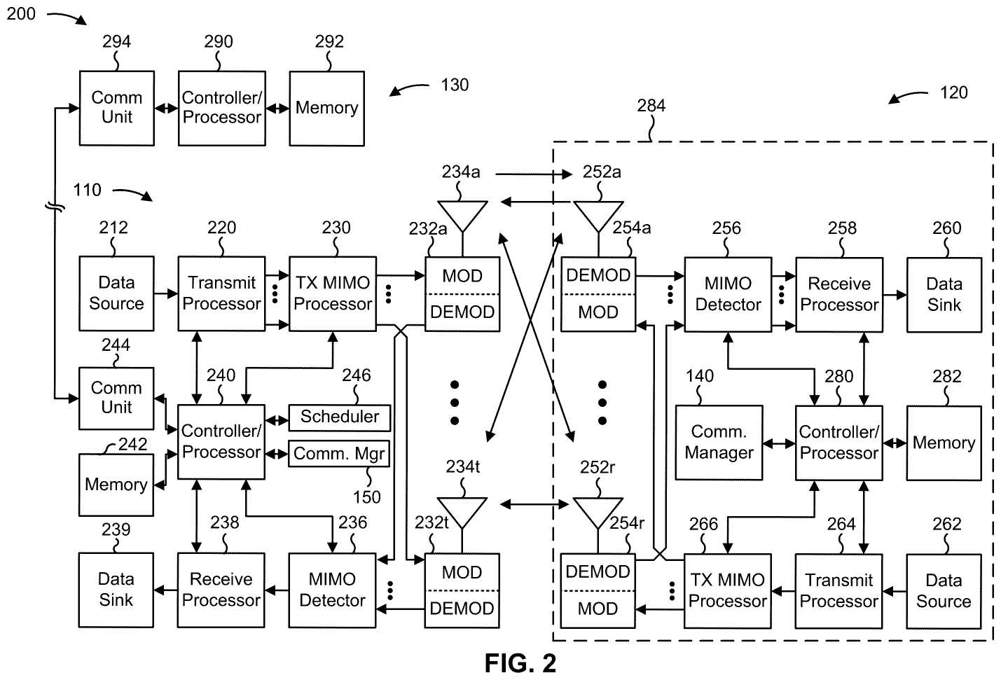

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

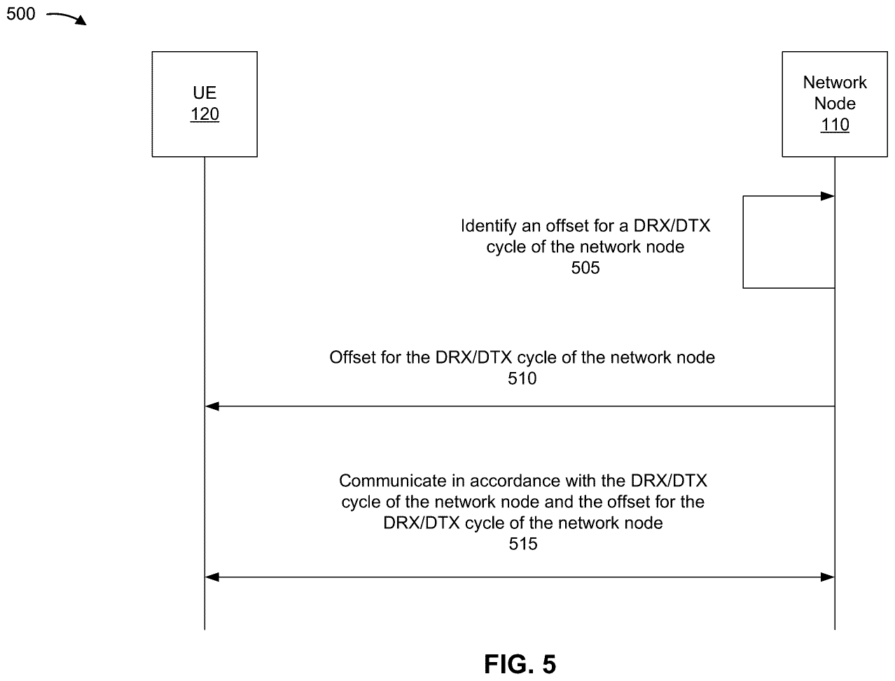

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 5-15).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 5-15).

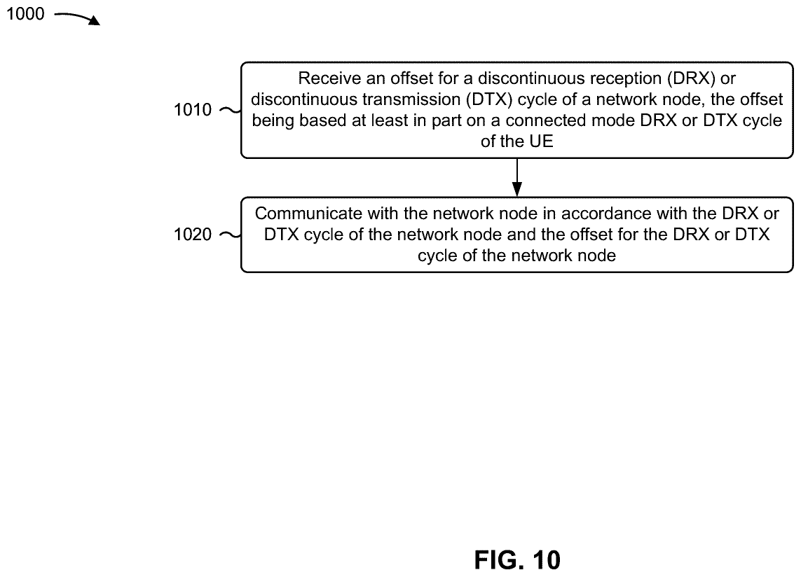

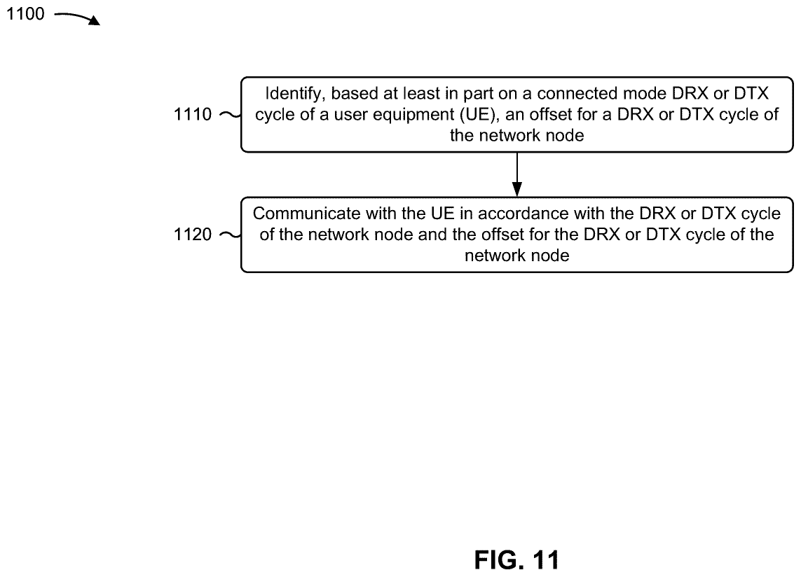

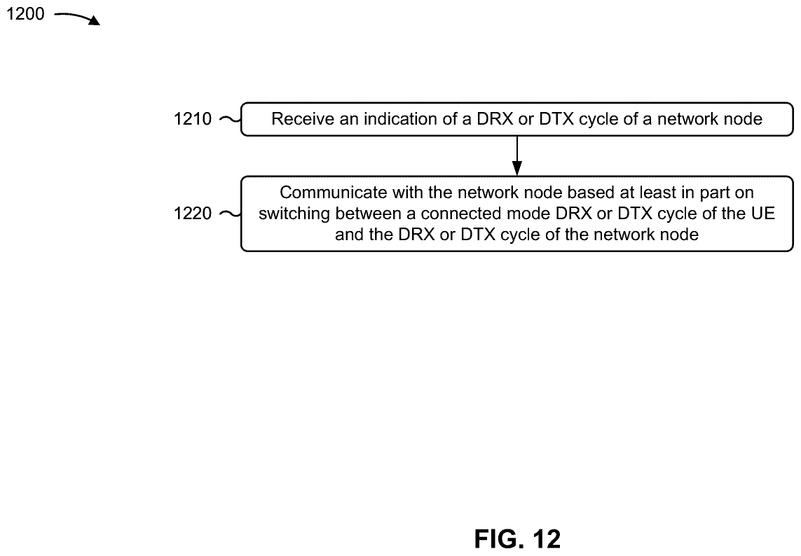

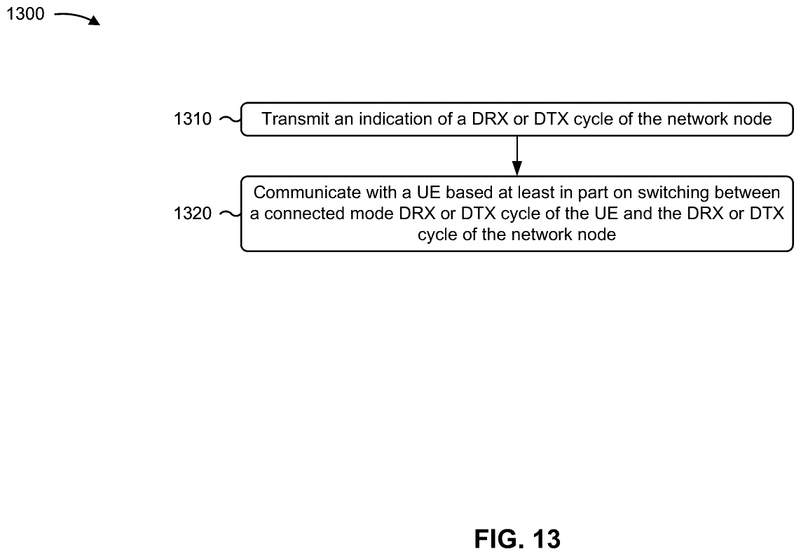

The controller/processor 240 of the network node 110, the controller/processor 280 of the UE 120, and/or any other component(s) of FIG. 2 may perform one or more techniques associated with network node DRX and DTX, as described in more detail elsewhere herein. For example, the controller/processor 240 of the network node 110, the controller/processor 280 of the UE 120, and/or any other component(s) of FIG. 2 may perform or direct operations of, for example, process 1000 of FIG. 10, process 1100 of FIG. 11, process 1200 of FIG. 12, process 1300 of FIG. 13, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 1000 of FIG. 10, process 1100 of FIG. 11, process 1200 of FIG. 12, process 1300 of FIG. 13, and/or other processes as described herein. In some examples, executing instructions may include running the instructions, converting the instructions, compiling the instructions, and/or interpreting the instructions, among other examples.

In some aspects, the UE 120 includes means for receiving an offset for a DRX or DTX cycle of a network node, the offset being based at least in part on a connected mode DRX or DTX cycle of the UE; and/or means for communicating with the network node in accordance with the DRX or DTX cycle of the network node and the offset for the DRX or DTX cycle of the network node. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for identifying, based at least in part on a connected mode DRX or DTX cycle of a UE, an offset for a DRX or DTX cycle of the network node; and/or means for communicating with the UE in accordance with the DRX or DTX cycle of the network node and the offset for the DRX or DTX cycle of the network node. The means for the network node 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, the UE 120 includes means for receiving an indication of a DRX or DTX cycle of a network node; and/or means for communicating with the network node based at least in part on switching between a connected mode DRX or DTX cycle of the UE and the DRX or DTX cycle of the network node. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for transmitting an indication of a DRX or DTX cycle of the network node; and/or means for communicating with a UE based at least in part on switching between a connected mode DRX or DTX cycle of the UE and the DRX or DTX cycle of the network node. The means for the network node 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (CNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

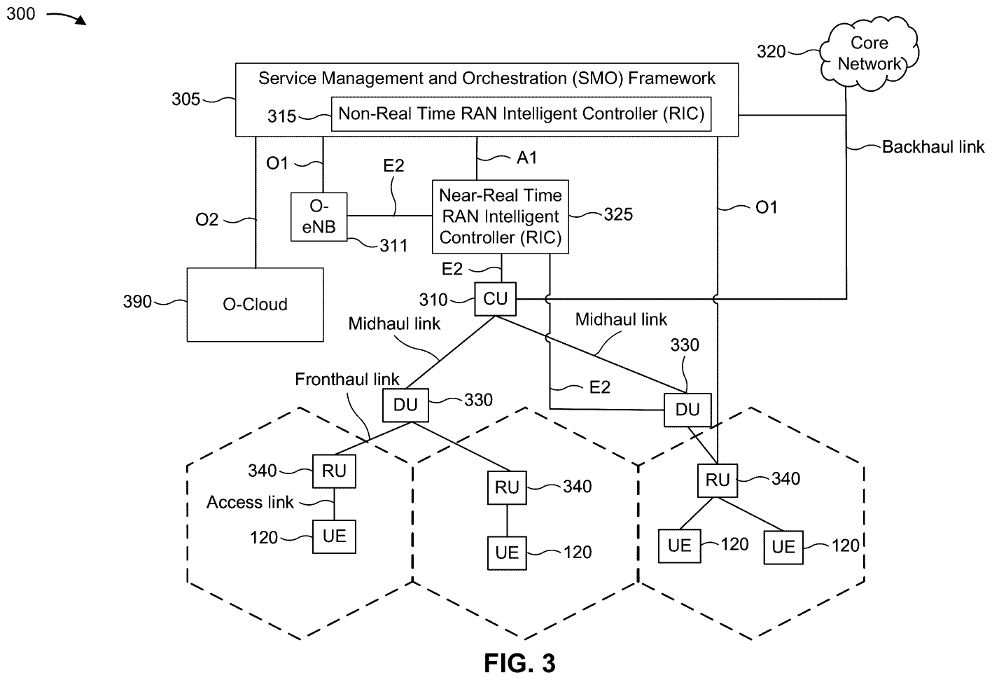

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-cNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

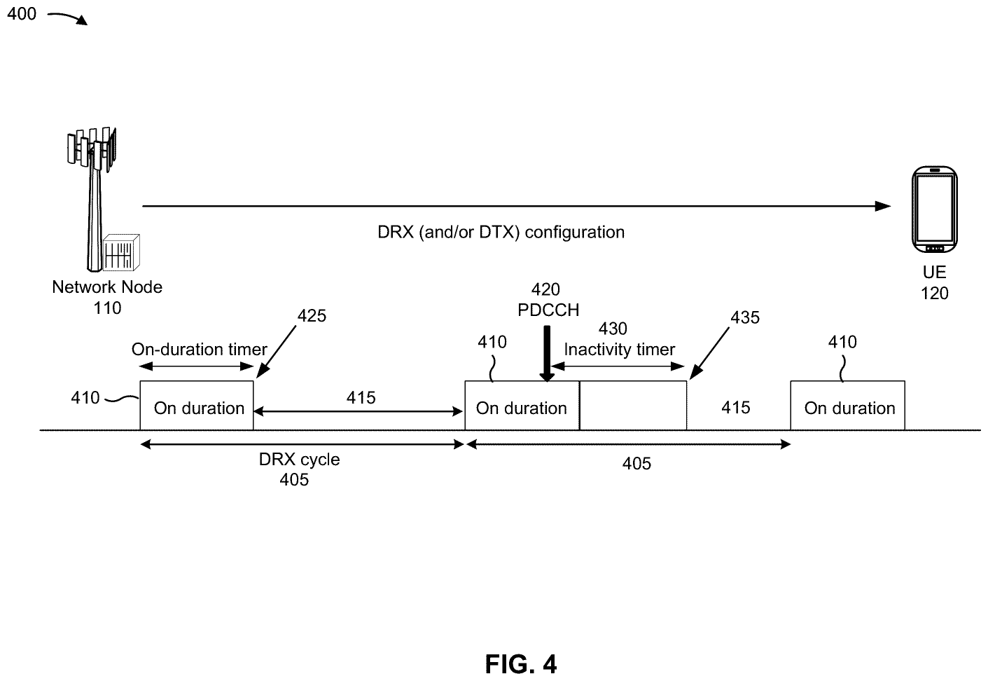

FIG. 4 is a diagram illustrating an example 400 of a DRX configuration, in accordance with the present disclosure.

As shown in FIG. 4, a network node 110 may transmit a DRX configuration to a UE 120 to configure a DRX cycle 405 for the UE 120. A DRX cycle 405 may include a DRX on duration 410 (e.g., during which a UE 120 is awake or in an active state) and an opportunity to enter a DRX sleep state 415. As used herein, the time during which the UE 120 is configured to be in an active state during the DRX on duration 410 may be referred to as an active time, and the time during which the UE 120 is configured to be in the DRX sleep state 415 may be referred to as an inactive time. As described below, the UE 120 may monitor a physical downlink control channel (PDCCH) during the active time, and may refrain from monitoring the PDCCH during the inactive time.

During the DRX on duration 410 (e.g., the active time), the UE 120 may monitor a downlink control channel (e.g., a PDCCH), as shown by reference number 420. For example, the UE 120 may monitor the PDCCH for downlink control information (DCI) pertaining to the UE 120. If the UE 120 does not detect and/or successfully decode any PDCCH communications intended for the UE 120 during the DRX on duration 410, then the UE 120 may enter the sleep state 415 (e.g., for the inactive time) at the end of the DRX on duration 410, as shown by reference number 425. In this way, the UE 120 may conserve battery power and reduce power consumption. As shown, the DRX cycle 405 may repeat with a configured periodicity according to the DRX configuration.

If the UE 120 detects and/or successfully decodes a PDCCH communication intended for the UE 120, then the UE 120 may remain in an active state (e.g., awake) for the duration of a DRX inactivity timer 430 (e.g., which may extend the active time). The UE 120 may start the DRX inactivity timer 430 at a time at which the PDCCH communication is received (e.g., in a transmission time interval (TTI) in which the PDCCH communication is received, such as a slot or a subframe). The UE 120 may remain in the active state until the DRX inactivity timer 430 expires, at which time the UE 120 may enter the sleep state 415 (e.g., for the inactive time), as shown by reference number 435. During the duration of the DRX inactivity timer 430, the UE 120 may continue to monitor for PDCCH communications, may obtain a downlink data communication (e.g., on a downlink data channel, such as a physical downlink shared channel (PDSCH)) scheduled by the PDCCH communication, and/or may prepare and/or transmit an uplink communication (e.g., on a physical uplink shared channel (PUSCH)) scheduled by the PDCCH communication. The UE 120 may restart the DRX inactivity timer 430 after each detection of a PDCCH communication for the UE 120 for an initial transmission (e.g., but not for a retransmission). By operating in this manner, the UE 120 may conserve battery power and reduce power consumption by entering the sleep state 415.

In some cases, the network node 110 may transmit a DTX configuration to the UE 120 to configure a DTX cycle for the UE 120. The DTX configuration may be similar (or identical) to the DRX configuration described herein. For example, the UE 120 may be configured to transmit to the network node 110 during a DTX active period (e.g., a DTX on duration) and may be configured to refrain from transmitting to network node 110 during a DTX inactive period (e.g., a DTX sleep duration). In some cases, the DRX configuration and the DTX configuration may have the same active duration and/or the same inactive duration. For example, the DRX configuration may be a combined DRX and DTX configuration. In some other cases, the DRX configuration and the DTX configuration may have different active durations and/or different inactive durations.

The DRX and DTX configuration for the UE 120 may enable the UE 120 to conserve battery power and to reduce power consumption by entering a sleep state when the UE 120 is not communicating with the network node 110. In some cases, the network node 110 may not be configured with a DRX or DTX configuration. For example, the network node 110 may be in an active state for an extended period of time, such as an indefinite period of time. Alternatively, the network node 110 may operate in accordance with a DRX or DTX configuration that does not align with a connected mode DRX or DTX configuration of the UE 120. For example, a DRX or DTX cycle of the network node 110 may be in an active state while the connected mode DRX or DTX configuration of the UE 120 is in an inactive state. This may result in wasted energy and processing resources by the network node 110.

Techniques and apparatuses are described herein for network node DRX and DTX. In some aspects, a network node may identify information associated with a DRX or DTX cycle of the network node. For example, the network node may identify at least one of an offset, a duration, or a periodicity associated with the DRX or DTX cycle of the network node. The information for the DRX or DTX cycle of the network node may be based at least in part on a connected mode DRX or DTX cycle of a UE. The UE may receive the information associated with the DRX or DTX cycle of the network node, and the UE and the network node may communicate in accordance with the DRX or DTX cycle of the network node and the information associated with the DRX or DTX cycle of the network node. This may enable the DRX or DTX cycle of the network node to be aligned with the connected mode DRX or DTX cycle of the UE. For example, the network node may enter an inactive period of the DRX or DTX cycle of the network node during an inactive period of the connected mode DRX or DTX cycle of the UE. In some aspects, the UE and/or the network node may switch between the DRX or DTX cycle of the network node and the connected mode DRX or DTX cycle of the UE. In some aspects, the DRX or DTX cycle of the network node may introduce additional downlink or uplink restrictions in addition to the restrictions imposed by the connected mode DRX or DTX cycle of the UE. Additionally, the DRX or DTX configuration of the network node may be dynamically adaptable. The DRX or DTX cycle of the network node may be aligned with the connected mode DRX or DTX cycle of the UE without requiring SSB changes and without impacting UEs in an idle or inactive mode. By operating in this manner, the network node may conserve energy and processing resources based at least in part on being aligned with the connected mode DRX or DTX cycle of the UE. Additional details are described herein.

As indicated above, FIG. 4 is provided as an example. Other examples may differ from what is described with respect to FIG. 4.

FIG. 5 is a diagram illustrating an example 500 of network node DRX and DTX, in accordance with the present disclosure.

As shown by reference number 505, the network node 110 may identify an offset for a DRX/DTX cycle of the network node 110. The DRX/DTX cycle of the network node 110 may be a DRX cycle in accordance with a DRX configuration of the network node 110, a DTX cycle in accordance with a DTX configuration of the network node 110, or a combined DRX and DTX cycle in accordance with a DRX and DTX configuration of the network node 110. The DRX/DTX cycle of the network node 110 may also be referred to as a cell DRX/DTX cycle.

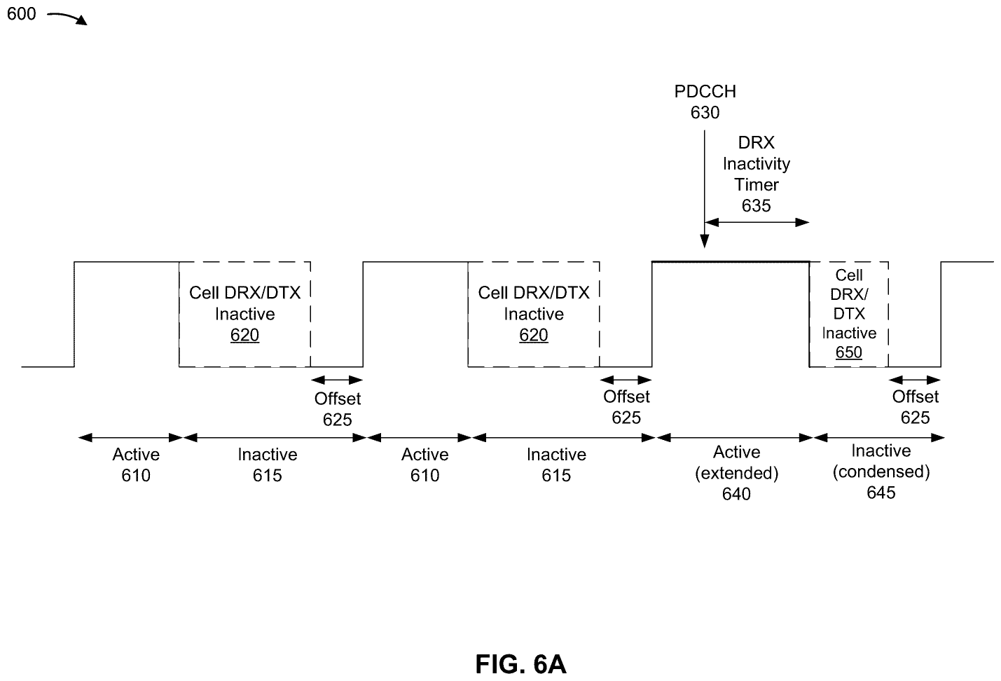

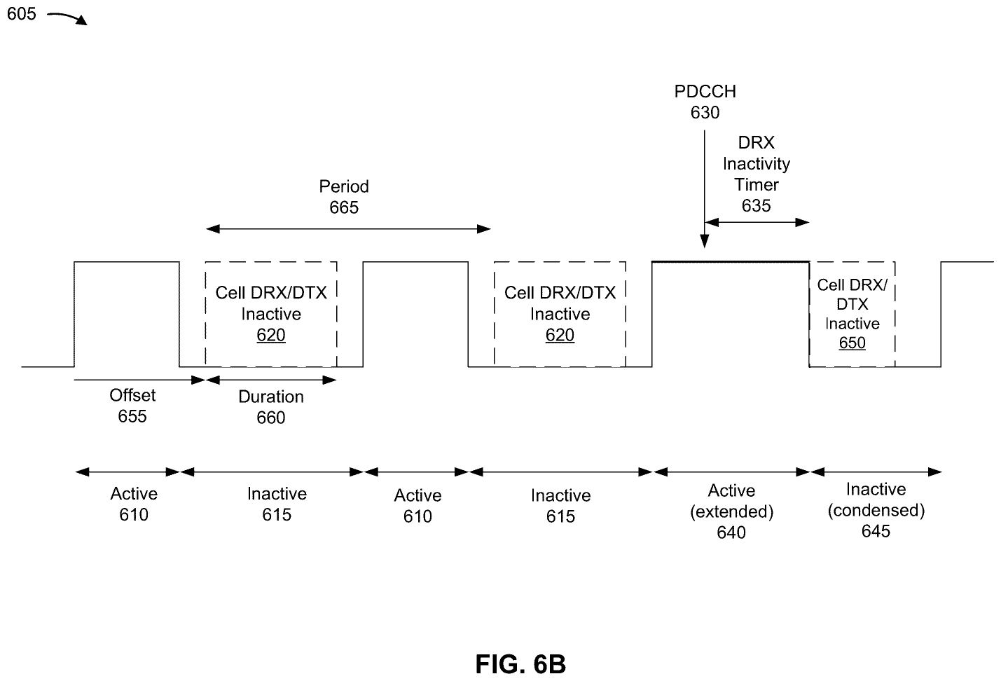

In a first example, the network node 110 may not be configured with an explicit or independent DRX/DTX configuration. Instead, a DRX/DTX cycle of the network node 110 may be based at least in part on a connected mode DRX/DTX cycle of the UE 120. For example, an inactive period of the DRX/DTX of the network node 110 may correspond to an inactive period of the connected mode DRX/DTX cycle of the UE 120. In some aspects, the inactive period of the DRX/DTX cycle of the network node 110 may overlap with at least a portion of the inactive period of the connected mode DRX/DTX cycle of the UE 120. For example, the inactive period of the DRX/DTX cycle of the network node 110 may start at a beginning of the inactive period of the connected mode DRX/DTX cycle of the UE 120 (and/or at an end of an active period of the connected mode DRX/DTX cycle of the UE 120), and may end prior to a start of a next active period of the connected mode DRX/DTX cycle of the UE 120. In some aspects, the offset may correspond to a time period that is between the end of the inactive period of the DRX/DTX cycle of the network node 110 and the start of the next active period of the connected mode DRX/DTX cycle of the UE 120. For example, the offset may correspond to a time period between the end of the inactive period of the DRX/DTX cycle of the network node 110 and the start of the next active period of the connected mode DRX/DTX cycle of the UE 120 during which no additional restrictions are applied. Additional details regarding these features are described in connection with FIG. 6A.

In a second example, the network node 110 may be configured with a DRX/DTX configuration. The DRX/DTX configuration of the network node 110 may be based at least in part on a connected mode DRX/DTX cycle of the UE 120. For example, the DRX/DTX configuration of the network node 110 may indicate one or more restrictions that are in addition to the restrictions for the connected mode DRX/DTX cycle of the UE 120. In some aspects, an inactive period of the DRX/DTX cycle of the network node 110 may be kept within an inactive period of the connected mode DRX/DTX cycle of the UE 120. If the inactive period of the DRX/DTX cycle of the network node 110 overlaps with an active period of the connected mode DRX/DTX cycle of the UE 120, the UE 120 may be configured to use the connected mode DRX/DTX configuration without applying any additional restrictions associated with the DRX/DTX cycle of the network node 110. In the second example, the network node 110 may identify the offset for the DRX/DTX cycle of the network node 110 and may identify at least one of a duration or a periodicity for the DRX/DTX cycle of the network node 110. The offset may be based at least in part on the duration or the periodicity, and/or may be based at least in part on an active period of the connected mode DRX/DTX cycle of the UE 120. The duration of the DRX/DTX cycle of the network node 110 may be based at least in part on the inactive period of the connected mode DRX/DTX cycle of the UE 120. For example, the duration may be less than the inactive period of the connected mode DRX/DTX cycle of the UE 120. The periodicity of the DRX/DTX cycle of the network node 110 may be the same as the periodicity of the connected mode DRX/DTX cycle of the UE 120. Alternatively, the periodicity of the DRX/DTX cycle of the network node 110 may be an integer multiple of the connected mode DRX/DTX cycle of the UE 120. For example, the periodicity of the DRX/DTX cycle of the network node 110 may be defined as the periodicity of the connected mode DRX/DTX cycle of the UE 120 multiplied by K, where K is an integer. Additional details regarding these features are described in connection with FIG. 6B.

As shown by reference number 510, the network node 110 may transmit, and the UE 120 may receive, information associated with the DRX/DTX cycle of the network node 110. In the first example described above, the network node 110 may transmit, and the UE 120 may receive, the offset for the DRX/DTX cycle of the network node 110. In the second example described above, the network node 110 may transmit, and the UE 120 may receive, the offset and at least one of the duration or the periodicity for the DRX/DTX cycle of the network node 110.

In some aspects, a cell group that includes a plurality of cells may be configured with a plurality of connected mode DRX/DTX configurations. In some aspects, one or more common DRX/DTX parameters (such as an offset, a duration, and/or a periodicity) may be defined for two or more of the connected mode DRX/DTX configurations. Additionally, or alternatively, two or more different DRX/DTX parameters may be defined for two or more of the connected mode DRX/DTX configurations. For example, a first cell in the cell group may be configured with a first set of DRX/DTX parameters and a second cell in the cell group may be configured with a second set of DRX/DTX parameters. Each parameter may be associated with one or more cells of the plurality of cells in the cell group.

In some aspects, RRC configuration information may indicate a plurality of candidate restrictions and/or a plurality of cells to which the restrictions are to be applied. For example, different restrictions may be applied to different cells or different groups of cells. In some aspects, dynamic Layer 1 (L1) or Layer 2 (L2) indications can be used to indicate which restrictions (of the plurality of candidate restrictions) are to be applied and/or to indicate which cells of the plurality of cells are to apply the restrictions. In some aspects, the restrictions may be applied to any downlink or uplink signals, such as semi-persistent scheduling (SPS) signals, configured grant (CG) PUSCH signals, scheduling request (SR) signals, and/or channel state information reference signal (CRI-RS) signals, among other examples. In some aspects, only a subset of the resources (e.g., SR or CG PUSCH) may be restricted and/or dynamically indicated. In some aspects, different logical channels may be mapped to the same SR, and a restriction may be indicated for a list of logical channel identifiers.

In some aspects, a plurality of parameters may be configured (e.g., RRC configured), and one or more parameters of the plurality of parameters may be indicated or activated using dynamic L1 or L2 signaling. The dynamic indication or activation may be cell-specific or may be applicable to a plurality of cells. In one example, a dynamic indication received on one cell may provide indications that are applicable only to that cell. In another example, a dynamic indication received on one cell may provide indications that are applicable to a plurality of cells. For example, the dynamic indication may (explicitly) indicate a plurality of other cells (or an index to a configured list of the plurality of other cells) and/or may provide cell-specific parameters or restrictions to be applied by the plurality of other cells. Alternatively, it may be (implicitly) assumed that the received indication is applicable to one or more other cells. The one or more other cells may be, for example, all cells associated with the same connected mode DRX/DTX configuration, all cells belonging to the same cell group, and/or all cells that are configured to share the same activation or cell DTX/DRX parameters.

In some aspects, a common dynamic indication may be used for activating and/or deactivating a cell DTX/DRX configuration, switching between a connected mode DRX/DTX cycle and a cell DRX/DTX cycle, and/or indicating one or more parameters, restrictions, and/or cells. In some aspects, a two-step indication may be supported. For example, the set of candidate restrictions and/or cells may be indicated using a medium access control (MAC) control element (MAC-CE), and a cell DRX/DTX may be activated, deactivated, or switched using DCI.

In some aspects, a cell may adopt a cell DRX/DTX configuration to restrict some or all of the uplink and/or downlink communications within a window. UEs in an idle mode or an inactive mode may not be configured with the cell DTX/DRX configuration. In contrast, UEs in a connected mode may be configured with the cell DRX/DTX configuration. A random access channel (RACH) Message 1 (MSG1) may be exempted from restrictions associated with the cell DRX/DTX configuration, for example, due to the impact on the UEs in the idle or inactive modes.

In some aspects, the UE 120 may be configured to monitor for a random access response (RAR) (for example, a RACH Message 2 (MSG2)) after sending the RACH MSG1 and during an RAR window. A subset of the resources used for monitoring the RAR may be within the cell DRX/DTX inactive period. A UE in an idle mode or an inactive mode may be configured to monitor all of the configured resources within the RAR window. In contrast, a UE in a connected mode that is configured with the cell DRX/DTX configuration may be configured to skip monitoring one or more of the resources within the RAR window. In some aspects, the network node 110 may indicate whether the RAR is to be skipped within the inactive period of the cell DRX/DTX. The indication may be included as part of the cell DRX/DTX configuration or activation. Additionally, or alternatively, the indication may be included as part of a PDCCH (such as for PDCCH-ordered RACH). In some aspects, the restriction or exemption may be applicable to specific types of RACH (such as contention-based random access (CBRA), contention-free random access (CFRA), beam failure recovery (BFR), or system information (SI), among other examples). In some aspects, one or more rules may be defined or configured to indicate whether RAR monitoring may be skipped and/or when the RAR monitoring may be skipped. The one or more rules may be based at least in part on a length of the RAR window, the cell DRX/DTX cycle, or a number of occasions that collide with the cell DRX/DTX inactive period, among other examples.

In some aspects, a cell DRX/DTX configuration associated with one or more neighboring cells may be indicated to the UE 120. The cell DRX/DTX configuration of the one or more neighboring cells may impact reference signals sent from the neighboring cells that are measured by the UE (such as a CSI-RS and/or a positioning reference signal (PRS), among other examples). This indication may be communicated via dedicated signaling, broadcast signaling, or multicast signaling, among other examples.

In some aspects, a common cell DRX/DTX configuration or pattern may be configured for a plurality of neighboring cells. Additionally, or alternatively, a cell DRX/DTX configuration or pattern of one or more neighboring cells may be common to the one or more neighboring cells and one or more serving cells. In either of these examples, a list of the neighboring cells may be indicated to the UE 120 when configuring the common cell DRX/DTX. In some aspects, the type of restrictions may be different for different neighboring cells (e.g., different neighboring cells may support different sets of restrictions). In one example, a list of restrictions may be indicated, and each item in the list of restrictions may indicate one or more types of restrictions and associated neighboring cells for which the restrictions are to be applied. In another example, a list of cells (or a group of cells) may be indicated, and one or more restrictions may be indicated for each cell in the list of cells.

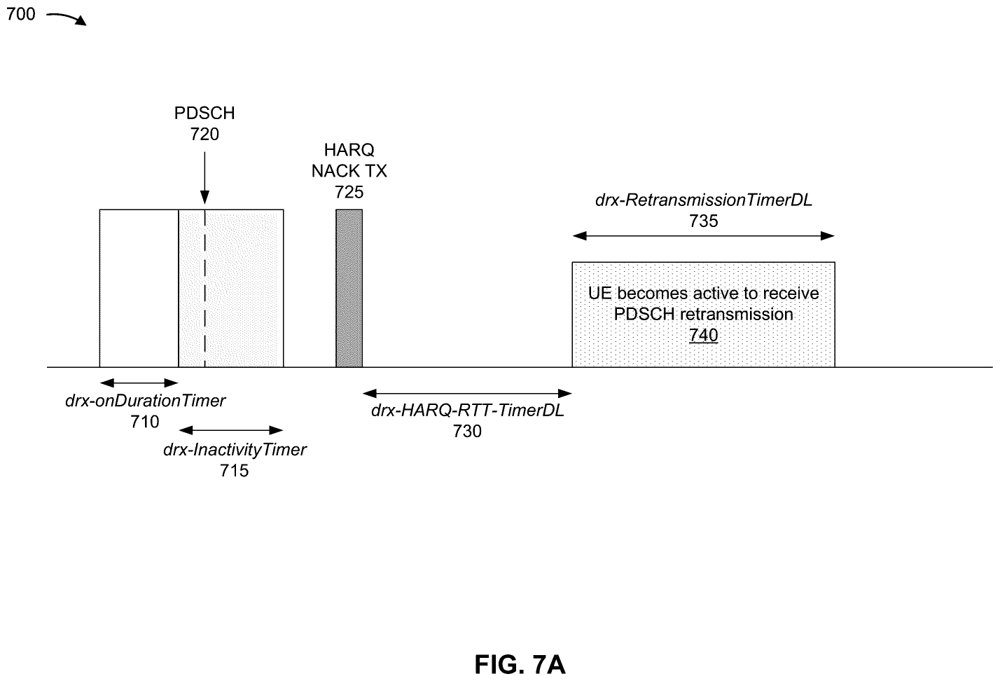

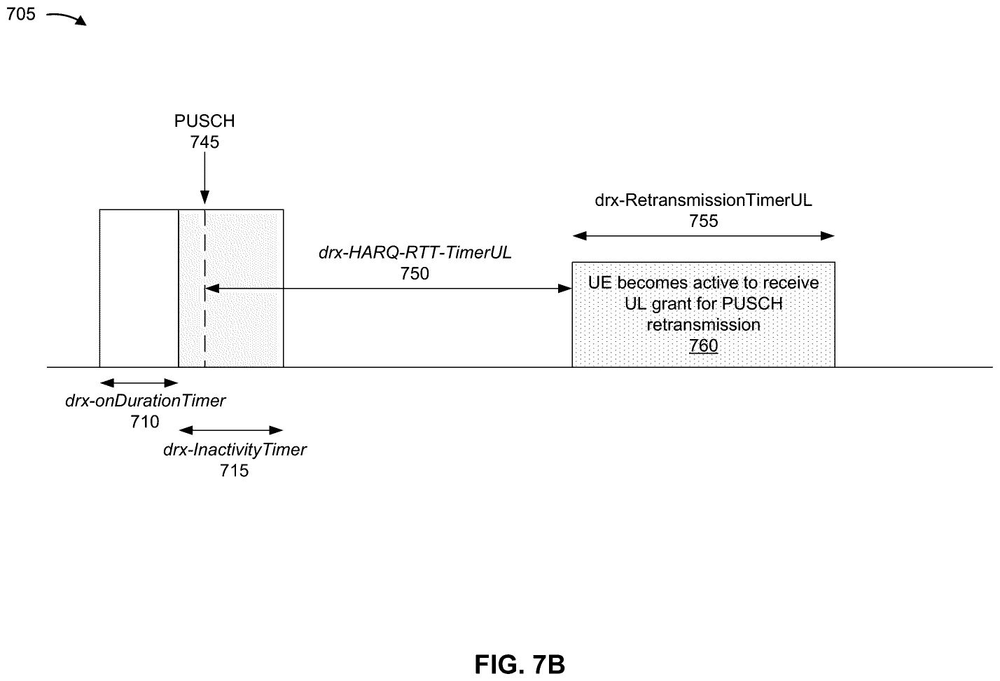

In some aspects, the cell DRX/DTX configuration may restrict or change one or more legacy connected mode DRX/DTX timers, for example, to create longer inactive durations. For example, the cell DRX/DTX configuration may restrict or change a DRX inactivity timer (drx-InactivityTimer), a DRX retransmission timer for uplink (drx-RetransmissionTimerUL), a DRX hybrid automatic repeat request (HARQ) round trip time (RTT) timer for uplink (drx-HARQ-RTT-TimerUL), a DRX retransmission timer for downlink (drx-RetransmissionTimerDL), and/or a DRX HARQ RTT timer for downlink (drx-HARQ-RTT-TimerDL). In some aspects, if the connected mode DRX/DTX active duration (e.g., the original ON duration and/or the extended active duration following the DRX inactivity timer) overlaps with the cell DRX/DTX inactive duration, the cell DRX/DTX may overwrite the connected mode DRX/DTX. For example, the UE 120 may assume that the cell will not be active during that time and may follow the corresponding transmission or reception restrictions associated with the cell DRX/DTX. Alternatively, the configuring cell DRX/DTX may change (implicitly or explicitly) the timer configuration of the underlying connected mode DRX/DTX. For example, the configuring cell DRX/DTX may implicitly change the DRX inactivity timer to a default value (such as zero) or explicitly indicate a new value for the DRX inactivity timer (and/or other timers). In some aspects, whether the cell DTX/DRX is to restrict the legacy timers and/or overwrite the legacy connected mode DRX/DTX may be configurable and/or indicated to the UE 120. Additional details regarding these features are described in connection with FIGS. 7A-7B.

In some aspects, one or more types of restrictions may be assumed to be default restrictions in accordance with a default configuration, for example, to reduce signaling overhead. In one example, the default restrictions may be configured or may be indicated (e.g., via broadcast or dedicated signaling). The default configuration may be specific to a single cell or may be general to a group of cells, including serving cells and/or neighboring cells. In some aspects, the default configuration may be able to be overwritten by future indications or configurations. In some other aspects, the default configuration may not be able to be overwritten by future indications or configurations.

As shown by reference number 515, the UE 120 and the network node 110 may communicate in accordance with the DRX/DTX cycle of the network node 110 and the offset for the DRX/DTX cycle of the network node 110.

As indicated above, FIG. 5 is provided as an example. Other examples may differ from what is described with respect to FIG. 5.

FIGS. 6A-6B are diagrams illustrating examples 600 and 605 of parameters for network node DRX and DTX, in accordance with the present disclosure.

As shown in FIG. 6A, a connected mode DRX/DTX cycle of the UE 120 may have an active period 610 and an inactive period 615 that repeat in accordance with an interval. The network node 110 may not be configured with an independent or explicit DRX/DTX configuration. Instead, the DRX/DTX cycle of the network node 110 may be based at least in part on the connected mode DRX/DTX cycle of the UE 120. For example, the cell DRX/DTX inactive period 620 may be located within the inactive period 615 of the connected mode DRX/DTX cycle. In some aspects, an offset 625 may correspond to a duration that is after an end of the cell DRX/DTX inactive period 620 and prior to a beginning of a next active period 610 of the connected mode DRX cycle. In some aspects, the UE 120 may receive a PDCCH 630 that triggers a DRX inactivity timer 635. The duration of the active period of the connected mode DRX/DTX cycle may be extended (as shown by reference number 640) during a duration of the DRX inactivity timer 635. Similarly, the duration of the inactive period of the connected mode DRX/DTX cycle may be condensed (as shown by reference number 645) based at least in part on an end of the DRX inactivity timer 635. In this case, the cell DRX/DTX inactive period 650 may also be condensed in accordance with the connected mode DRX/DTX cycle and the offset 625. For example, the cell DRX/DTX inactive period 650 may be condensed so as to not overlap with the active period 610 of the connected mode DRX/DTX cycle or the offset 625.

As shown in FIG. 6B, the cell DRX/DTX cycle may be associated with one or more of an offset 655, a duration 660, and a period 665. The offset 655 may be based at least in part on the duration 660 and/or the periodicity 665, and/or may be based at least in part on an active period 610 of the connected mode DRX/DTX cycle of the UE 120. The duration 660 of the DRX/DTX cycle of the network node 110 may be based at least in part on the inactive period 615 of the connected mode DRX/DTX cycle of the UE 120. For example, the duration 660 may be less than the inactive period 615 of the connected mode DRX/DTX cycle. The periodicity 665 of the DRX/DTX cycle of the network node 110 may be the same as the periodicity of the connected mode DRX/DTX cycle of the UE 120. Alternatively, the periodicity 665 of the DRX/DTX cycle of the network node 110 may be an integer multiple of the connected mode DRX/DTX cycle of the UE 120. For example, the periodicity 665 of the DRX/DTX cycle of the network node 110 may be defined as the periodicity of the connected mode DRX/DTX cycle of the UE 120 multiplied by K.

As indicated above, FIGS. 6A-6B are provided as examples. Other examples may differ from what is described with respect to FIGS. 6A-6B.

FIGS. 7A-7B are diagrams illustrating examples 700 and 705 of DRX and DTX timers, in accordance with the present disclosure.

As shown in FIG. 7A, a connected mode DRX/DTX cycle may be active during a duration of a drx-onDurationTimer 710 and may be inactive during a duration of a drx-InactivityTimer 715. In some aspects, the network node 110 may transmit a PDSCH 720 during the inactive period of the connected mode DRX/DTX cycle. Thus, the UE 120 may not receive the PDSCH 720. The UE 120 may transmit a HARQ negative acknowledgement (NACK) message 725 at a time that is after an expiration of the drx-Inactivity Timer 715. The transmission of the HARQ NACK 725 may cause a drx-HARQ-RTT-TimerDL 730 to become active for a duration. The UE 120 may initiate a drx-RetransmissionTimerDL 735 based at least in part on (e.g., after) an expiration of the drx-HARQ-RTT-TimerDL 730. As shown by reference number 740, the UE 120 may become active to receive a PDSCH retransmission during the drx-RetransmissionTimerDL 735.

As shown in FIG. 7B, the UE 120 may transmit a PUSCH 745 during an inactive period of the connected mode DRX/DTX cycle. The UE 120 may initiate a drx-HARQ-RTT-timerUL 750 based at least in part on transmitting the PUSCH 745. The UE 120 may initiate a drx-RetransmissionTimerUL 755 based at least in part on (e.g., after) an expiration of the drx-HARQ-RTT-TimerUL 750. As shown by reference number 760, the UE 120 may become active to receive an uplink grant for PUSCH retransmission during the drx-RetransmissionTimerUL 755.

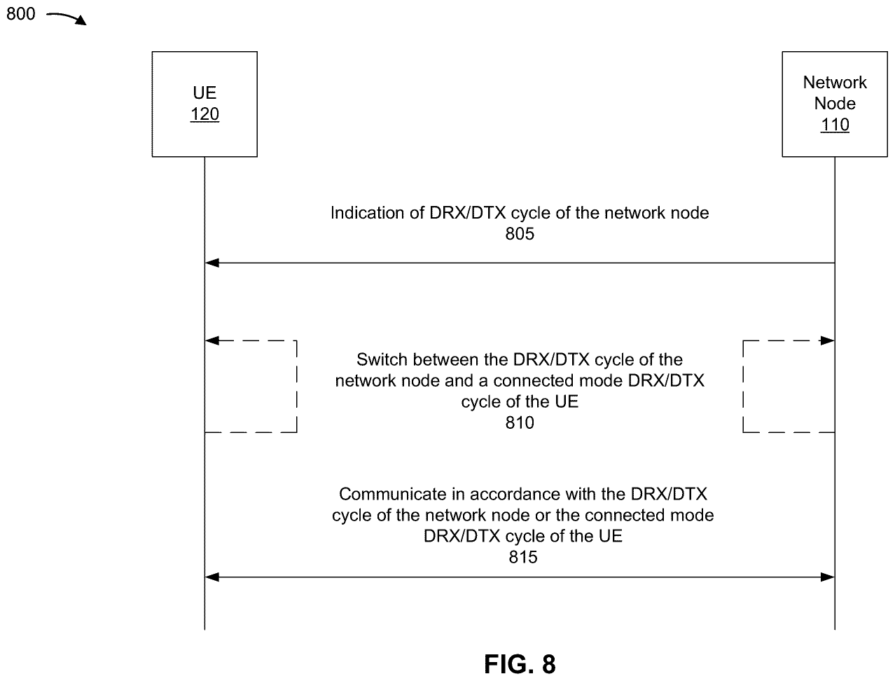

FIG. 8 is a diagram illustrating an example 800 of network node DRX and DTX, in accordance with the present disclosure.

As shown by reference number 805, the network node 110 may identify an offset for a DRX/DTX cycle of the network node 110. The DRX/DTX cycle of the network node 110 may be a DRX cycle in accordance with a DRX configuration of the network node 110, a DTX cycle in accordance with a DTX configuration of the network node 110, or a combined DRX and DTX cycle in accordance with a DRX and DTX configuration of the network node 110. The DRX/DTX cycle of the network node 110 may also be referred to as a cell DRX/DTX cycle.

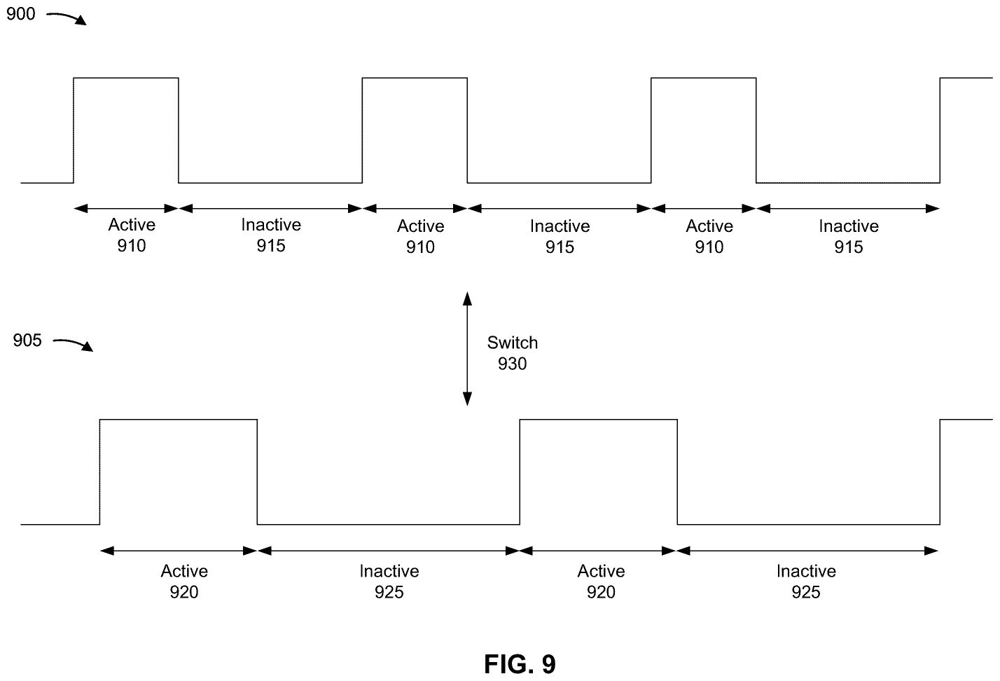

In some aspects, the DRX/DTX configuration for the network node 110 may be configured independently from a connected mode DRX/DTX cycle of the UE 120. For example, a DRX/DTX cycle of the network node 110 may not align with a connected mode DRX/DTX cycle of the UE 120. The UE 120 and/or the network node 110 may be configured to operate in accordance with the DRX/DTX configuration for the network node 110 (e.g., using the cell DRX/DTX cycle) or in accordance with the connected mode DRX/DTX configuration for the UE 120 (e.g., using the connected mode DRX/DTX cycle) at a particular time. The UE 120 and the network node 110 may not operate in accordance with the DRX/DTX configuration for the network node 110 and in accordance with the connected mode DRX/DTX configuration for the UE 120 at the same time. The DRX/DTX configuration for the network node 110 may be based at least in part on the connected mode DRX/DTX configuration for the UE 120. For example, the DRX/DTX configuration for the network node 110 may borrow a baseline design (e.g., in terms of rules and timers, among other examples) from the connected mode DRX/DTX configuration for the UE 120. In some aspects, a flag may be used to indicate whether the baseline connected mode DRX/DTX cycle rules are applicable to the cell DRX/DTX cycle. The DRX/DTX configuration for the network node 110 may provide additional restrictions on top of the restrictions associated with the connected mode DRX/DTX configuration for the UE 120. In some aspects, the DRX/DTX for the network node 110 may support dynamic adaptation. This may allow the UE 120 and the network node 110 to be configured with the connected mode DRX/DTX configuration and the cell DRX/DTX configuration (for example, with different parameters in terms of offset, duration, and/or periodicity) and to dynamically switch between the two configurations. In some aspects, one or more default parameter values, such as values for the offset, duration, and/or periodicity for the cell DRX/DTX configuration, may be RRC configured to the UE 120. The one or more default parameter values may be assumed to be the same as the connected mode DRX/DTX configuration, unless otherwise indicated. In some aspects, the cell DRX/DTX configuration may be explicitly indicated to be associated with a configured connected mode DRX/DTX configuration. Additional details regarding these features are described in connection with FIG. 9.

In some aspects, RRC configuration information may indicate a plurality of candidate restrictions and/or a plurality of cells to which the restrictions are to be applied. For example, different restrictions may be applied to different cells or different groups of cells. In some aspects, dynamic L1 or L2 indications can be used to indicate which restrictions (of the plurality of candidate restrictions) are to be applied and/or to indicate which cells of the plurality of cells are to apply the restrictions. In some aspects, the restrictions may be applied to any downlink or uplink signals, such as SPS signals, CG PUSCH signals, SR signals, and/or CRI-RS signals, among other examples. In some aspects, only a subset of the resources (e.g., SR or CG PUSCH) may be restricted and/or dynamically indicated. In some aspects, different logical channels may be mapped to the same SR, and a restriction may be indicated for a list of logical channel identifiers.

In some aspects, a plurality of parameters may be configured (e.g., RRC configured), and one or more parameters of the plurality of parameters may be indicated or activated using dynamic L1 or L2 signaling. The dynamic indication or activation may be cell-specific or may be applicable to a plurality of cells. In one example, a dynamic indication received on one cell may provide indications that are applicable only to that cell. In another example, the dynamic indication received on one cell may provide indications that are applicable to a plurality of cells. For example, the dynamic indication may (explicitly) indicate a plurality of other cells (or an index to a configured list of the plurality of other cells) and/or may provide cell-specific parameters or restrictions to be applied by the plurality of other cells. Alternatively, it may be (implicitly) assumed that the received indication is applicable to one or more other cells. The one or more other cells may be, for example, all cells associated with the same connected mode DRX/DTX configuration, all cells belonging to the same cell group, and/or all cells that are configured to share the same activation or cell DTX/DRX parameters.

In some aspects, a common dynamic indication may be used for activating and/or deactivating a cell DTX/DRX configuration, switching between a connected mode DRX/DTX cycle and a cell DRX/DTX cycle, and/or indicating one or more parameters, restrictions, and/or cells. In some aspects, a two-step indication may be supported. For example, the set of candidate restrictions and/or cells may be indicated using a MAC-CE, and a cell DRX/DTX may be activated, deactivated, or switched using DCI.

In some aspects, a cell may adopt a cell DRX/DTX configuration to restrict some or all of the uplink and/or downlink communications within a window. UEs in an idle mode or an inactive mode may not be configured with the cell DTX/DRX configuration. In contrast, UEs in a connected mode may be configured with the cell DRX/DTX configuration. A RACH MSG1 may be exempted from restrictions associated with the cell DRX/DTX configuration, for example, due to the impact on the UEs in the idle or inactive modes.

In some aspects, the UE 120 may be configured to monitor for an RAR (for example, a RACH MSG2) after sending the RACH MSG1 and during an RAR window. A subset of the resources used for monitoring the RAR may be within the cell DRX/DTX inactive period. A UE in an idle mode or an inactive mode may be configured to monitor all of the configured resources within the RAR window. In contrast, a UE in a connected mode that is configured with the cell DRX/DTX configuration may be configured to skip monitoring one or more of the resources within the RAR window. In some aspects, the network node 110 may indicate whether the RAR is to be skipped within the inactive period of the cell DRX/DTX. The indication may be included as part of the cell DRX/DTX configuration or activation. Additionally, or alternatively, the indication may be included as part of a PDCCH (such as for PDCCH-ordered RACH). In some aspects, the restriction or exemption may be applicable to specific types of RACH (such as CBRA, CFRA, BFR, or SI, among other examples). In some aspects, one or more rules may be defined or configured to indicate whether RAR monitoring may be skipped and/or when the RAR monitoring may be skipped. The one or more rules may be based at least in part on a length of the RAR window, the cell DRX/DTX cycle, or a number of occasions that collide with the cell DRX/DTX inactive period, among other examples.

In some aspects, a cell DRX/DTX configuration associated with one or more neighboring cells may be indicated to the UE 120. The cell DRX/DTX configuration of the one or more neighboring cells may impact reference signals sent from the neighboring cells that are measured by the UE (such as a CSI-RS and/or a PRS, among other examples). This indication may be communicated via dedicated signaling, broadcast signaling, or multicast signaling, among other examples.

In some aspects, a common cell DRX/DTX configuration or pattern may be configured for a plurality of neighboring cells. Additionally, or alternatively, a cell DRX/DTX configuration or pattern of one or more neighboring cells may be common to the one or more neighboring cells and one or more serving cells. In either of these examples, a list of the neighboring cells may be indicated to the UE 120 when configuring the common cell DRX/DTX. In some aspects, the type of restrictions may be different for different neighboring cells (e.g., different neighboring cells may support different sets of restrictions). In one example, a list of restrictions may be indicated, and each item in the list of restrictions may indicate one or more types of restrictions and associated neighboring cells for which the restrictions are to be applied. In another example, a list of cells (or a group of cells) may be indicated, and one or more restrictions may be indicated for each cell in the list of cells.

In some aspects, one or more types of restrictions may be assumed to be default restrictions in accordance with a default configuration, for example, to reduce signaling overhead. In one example, the default restrictions may be configured or may be indicated (e.g., via broadcast or dedicated signaling). The default configuration may be specific to a single cell or may be general to a group of cells, including serving cells and/or neighboring cells. In some aspects, the default configuration may be able to be overwritten by future indications or configurations. In some other aspects, the default configuration may not be able to be overwritten by future indications or configurations.

As shown by reference number 810, the UE 120 and/or the network node 110 may switch between the DRX/DTX cycle of the network node 110 and the connected mode DRX/DTX cycle of the UE 120. For example, the UE 120 may switch between the cell DRX/DTX configuration and the connected mode DRX/DTX configuration. Additionally, or alternatively, the network node 110 may switch between the cell DRX/DTX configuration and the connected mode DRX/DTX configuration. In some aspects, the network node 110 may transmit, and the UE 120 may receive, a dynamic indication (such as using L1 or L2 signaling) that indicates for the UE 120 to switch between the cell DRX/DTX configuration and the connected mode DRX/DTX configuration.

As shown by reference number 815, the UE 120 and the network node 110 may communicate in accordance with the DRX/DTX cycle of the network node 110 or the connected mode DRX/DTX cycle of the UE 120.

As indicated above, FIG. 8 is provided as an example. Other examples may differ from what is described with respect to FIG. 8.

FIG. 9 is a diagram illustrating examples of DRX and DTX configuration switching, in accordance with the present disclosure. As described herein, the UE 120 and/or the network node 110 may be configured with multiple DRX/DTX configurations 900 and 905. For example, the UE 120 and/or the network node 110 may be configured with a first DRX/DTX configuration 900 that corresponds to a connected mode DRX/DTX configuration of the UE 120. The first DRX/DTX configuration 900 may have an active duration 910 and an inactive duration 915 that repeat in accordance with an interval. The first DRX/DTX configuration 900 may have a first offset, a first duration, and a first periodicity. Additionally, the UE 120 and/or the network node 110 may be configured with a second DRX/DTX configuration 905 that corresponds to a DRX/DTX configuration of the network node 110. The second DRX/DTX configuration 905 may have an active duration 920 and an inactive duration 925 that repeat in accordance with an interval. The second DRX/DTX configuration 905 may have a second offset, a second duration, and a second periodicity. As shown by reference number 930, the UE 120 and/or the network node 110 may be configured to switch between the first DRX/DTX configuration 900 and the second DRX/DTX configuration 905. In some aspects, the network node 110 may transmit, and the UE 120 may receive, a dynamic indication (using L1 or L2 signaling) that indicates for the UE 120 to switch between the first DRX/DTX configuration 900 and the second DRX/DTX configuration 905.

As indicated above, FIG. 9 is provided as an example. Other examples may differ from what is described with respect to FIG. 9.

In some cases, a UE may not be configured (e.g., may not be allowed) to transmit an SR during a cell DRX/DTX inactive period. In this case, the UE may be configured to drop the SR. For example, the UE may drop the SR, and wait for a next transmission occasion or assume that an SR physical uplink control channel (PUCCH) resource is not available.

In a first example, the UE may maintain the SR as pending, and the SR transmission may be delayed until the cell DRX active period. This may result in one or more issues. For example, the SR may be pending indefinitely since there may be no limit on the length of the cell DRX/DTX inactive period or the amount of SR occasions that are canceled by the cell DRX/DTX. Additionally, the network node may not be able to determine that the SR is pending. In some cases, extended pending SR may cause service degradation and/or may result in radio link failure (RLF). In a second example, the UE may initiate a random access (RA) SR and may cancel the pending SR. This may result in one or more issues. For example, this may result in high power consumption. Saving energy by muting the SR, only for the UE to trigger a RACH, may consume both UE and network energy (e.g., more energy than if the SR were transmitted). Additionally, the RACH may take significant time to complete and may extend after the cell DRX/DTX active period (e.g., depending on a next RACH occasion (RO) position). In a third example, the UE may perform one or more other actions, for example, depending on whether there is a PRACH resource before the cell DRX/DTX active period. This may result in complex processing by the UE, for example, to base the MAC behavior on future PRACH resources as well as cell DRX/DTX configurations (that may be changing).

In some aspects, the UE may maintain the SR as pending (e.g., may keep the SR pending) for a duration, such as a maximum duration, and may trigger a delayed SR-RACH based at least in part on no PUCCH occasions being available. In some aspects, this may be signaled as part of a scheduling request configuration (SchedulingRequestConfig) using RRC and as an SR maximum pending timer (SRMaxPendingTimer). The timer may be started based at least in part on SR PUCCH cancellation, for example, due to overlap with a cell DRX/DTX inactive period. The timer may be stopped and reset if the pending SR is transmitted before the timer expires. In some aspects, the delayed SR-RACH may be signaled as part of cell DRX/DTX configuration (or a general RRC configuration) and may and apply to all SR configurations for all logical channels (LCH). In some aspects, the maximum time may be a maximum time that is configured by the UE. For example, the UE may keep the SR pending or may trigger the RACH based at least in part on the maximum time that is configured by the UE.

In some aspects, after an expiration of the timer and if one or more RACH occasions are available, the UE may determine to wait for one or more other SR PUCCH resources (e.g., in an upcoming active duration of the cell DRX/DTX) to send the SR. For example, the UE may determine that going through the RACH process (e.g., sending the MSG1 and receiving the MSG2) may take longer than waiting for the next available or non-canceled SR resource. In one example, the UE may initiate the RACH process by sending the MSG1, but a first transmission may not be successful. In this case, the UE may need to perform RACH retransmission. At this point, if one or more SR PUCCH resources become available, the UE may decide to skip the RACH retransmission and send the SR in the associated PUCCH resources.

In some aspects, if the timer expires while the SR is pending, the UE may initiate a random access procedure on a special cell (SpCell) and may cancel the pending SR. For example, the UE may initiate the random access procedure on the SpCell and may cancel the pending SR in accordance with TS 38.321 clause 5.1 of the 3GPP Specification.

In some aspects, the UE may be configured with a SRCellDRXBypassTimer by RRC and per SR configuration. This timer may be started based at least in part on SR PUCCH cancellation due to overlap with the cell DRX/DTX inactive period. The timer may be stopped and reset if the pending SR is transmitted before the timer expires. When the timer expires, the UE may transmit the SR on a next PUCCH occasion, regardless of whether the next PUCCH occasion overlaps with the cell DRX/DTX active period. In some aspects, the timer may be jointly or separately configured from the SRMaxPending Timer.

FIG. 10 is a diagram illustrating an example process 1000 performed, for example, by a UE, in accordance with the present disclosure. Example process 1000 is an example where the UE (e.g., UE 120) performs operations associated with network node discontinuous reception and transmission.

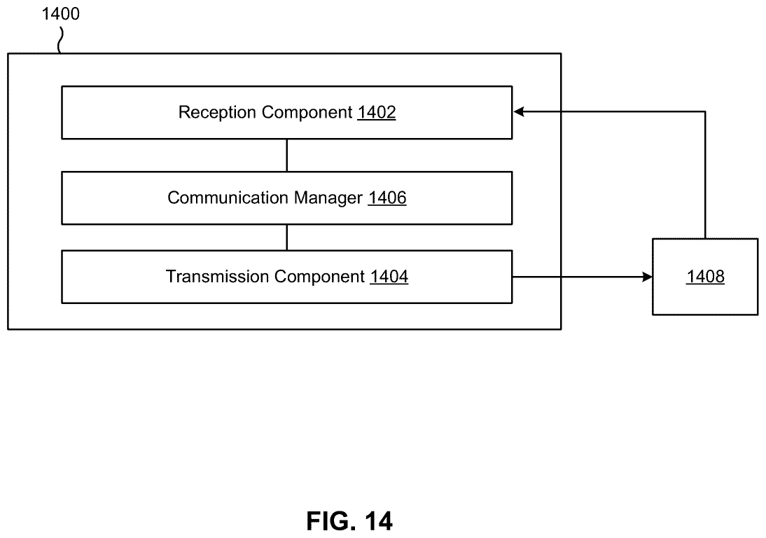

As shown in FIG. 10, in some aspects, process 1000 may include receiving an offset for a DRX or DTX cycle of a network node, the offset being based at least in part on a connected mode DRX or DTX cycle of the UE (block 1010). For example, the UE (e.g., using reception component 1402 and/or communication manager 1406, depicted in FIG. 14) may receive an offset for a DRX or DTX cycle of a network node, the offset being based at least in part on a connected mode DRX or DTX cycle of the UE, as described above.

As further shown in FIG. 10, in some aspects, process 1000 may include communicating with the network node in accordance with the DRX or DTX cycle of the network node and the offset for the DRX or DTX cycle of the network node (block 1020). For example, the UE (e.g., using reception component 1402, transmission component 1404, and/or communication manager 1406, depicted in FIG. 14) may communicate with the network node in accordance with the DRX or DTX cycle of the network node and the offset for the DRX or DTX cycle of the network node, as described above.

Process 1000 may include additional aspects, such as any single aspect or any combination of aspects described below and/or in connection with one or more other processes described elsewhere herein.

In a first aspect, the DRX or DTX cycle of the network node is associated with the connected mode DRX or DTX cycle of the UE.

In a second aspect, alone or in combination with the first aspect, an inactive duration of the DRX or DTX cycle of the network node overlaps with at least a portion of an inactive duration of the connected mode DRX or DTX cycle of the UE.

In a third aspect, alone or in combination with one or more of the first and second aspects, the offset corresponds to a time period that is between an end of the inactive duration of the DRX or DTX cycle of the network node and a start of an active duration of the connected mode DRX or DTX cycle of the UE.

In a fourth aspect, alone or in combination with one or more of the first through third aspects, the DRX or DTX cycle of the network node includes one or more restrictions to be applied to the connected mode DRX or DTX cycle of the UE.

In a fifth aspect, alone or in combination with one or more of the first through fourth aspects, an inactive duration of the DRX or DTX cycle of the network node is within an inactive duration of the connected mode DRX or DTX cycle of the UE.

In a sixth aspect, alone or in combination with one or more of the first through fifth aspects, communicating with the network node comprises communicating with the network node during an active duration of the connected mode DRX or DTX cycle of the UE based at least in part on an inactive duration of the DRX or DTX cycle of the network node overlapping with the active duration of the connected mode DRX or DTX cycle of the UE.

In a seventh aspect, alone or in combination with one or more of the first through sixth aspects, receiving the offset for the DRX or DTX cycle of the network node comprises receiving the offset and at least one of a duration or a periodicity for the DRX or DTX cycle of the network node.

In an eighth aspect, alone or in combination with one or more of the first through seventh aspects, the offset is based at least in part on the duration or the periodicity for the DRX or DTX cycle of the network node or based at least in part on an active duration of the connected mode DRX or DTX cycle of the UE, wherein the duration for the DRX or DTX cycle of the network node is less than an inactive duration of the connected mode DRX or DTX cycle of the UE, and wherein the periodicity for the DRX or DTX cycle of the network node is equal to a periodicity of the connected mode DRX or DTX cycle of the UE or is an integer multiple of the periodicity of the connected mode DRX or DTX cycle of the UE.

In a ninth aspect, alone or in combination with one or more of the first through eighth aspects, process 1000 includes receiving radio resource control configuration information that indicates a plurality of candidate restrictions and a plurality of candidate cells associated with the DRX or DTX cycle of the network node.

In a tenth aspect, alone or in combination with one or more of the first through ninth aspects, L1 or L2 information is used to indicate a restriction, from the plurality of candidate restrictions, to be applied to the DRX or DTX cycle of the network node, or to indicate a cell, of the plurality of candidate cells, for which the restriction is to be applied.

In an eleventh aspect, alone or in combination with one or more of the first through tenth aspects, the restriction applies to one or more resources of a plurality of resources associated with the DRX or DTX cycle of the network node.

In a twelfth aspect, alone or in combination with one or more of the first through eleventh aspects, process 1000 includes receiving radio resource control configuration information that indicates a plurality of parameters associated with the DRX or DTX cycle of the network node, and L1 or L2 information indicates a parameter of the plurality of parameters to be applied to the DRX or DTX cycle of the network node.

In a thirteenth aspect, alone or in combination with one or more of the first through twelfth aspects, the L1 or L2 information is specific to a cell of a plurality of cells that transmit the L1 or L2 information.

In a fourteenth aspect, alone or in combination with one or more of the first through thirteenth aspects, the L1 or L2 information is configured to be applied by a plurality of cells that transmit the L1 or L2 information.

In a fifteenth aspect, alone or in combination with one or more of the first through fourteenth aspects, process 1000 includes receiving an indication of a plurality of resources to be used for monitoring for a random access response message after a random access channel MSG1 and during a random access response window, wherein one or more resources of the plurality of resources are within an inactive duration of the DRX or DTX cycle of the network node.

In a sixteenth aspect, alone or in combination with one or more of the first through fifteenth aspects, process 1000 includes receiving an indication to refrain from monitoring the one or more resources that are within the inactive duration of the DRX or DTX cycle of the network node, wherein the indication to refrain from monitoring the one or more resources that are within the inactive duration of the DRX or DTX cycle of the network node is included in a DRX or DTX cycle configuration or a physical downlink control channel message.

In a seventeenth aspect, alone or in combination with one or more of the first through sixteenth aspects, process 1000 includes refraining from monitoring the one or more resources that are within the inactive duration of the DRX or DTX cycle of the network node based at least in part on receiving the indication to refrain from monitoring the one or more resources that are within the inactive duration of the DRX or DTX cycle of the network node.

In an eighteenth aspect, alone or in combination with one or more of the first through seventeenth aspects, process 1000 includes receiving an indication of one or more rules for refraining from monitoring the one or more resources that are within the inactive duration of the DRX or DTX cycle of the network node.

In a nineteenth aspect, alone or in combination with one or more of the first through eighteenth aspects, process 1000 includes receiving an indication of a DRX or DTX cycle of a neighbor cell of the network node, wherein the neighbor cell is within a distance of the network node that is less than a distance threshold.

In a twentieth aspect, alone or in combination with one or more of the first through nineteenth aspects, the DRX or DTX cycle of the neighbor cell is a common DRX or DTX cycle that is shared by the network node and the neighbor cell or by the neighbor cell and a serving cell.

In a twenty-first aspect, alone or in combination with one or more of the first through twentieth aspects, process 1000 includes receiving an indication of one or more restrictions associated with the common DRX or DTX cycle, wherein the indication of the one or more restrictions indicates one or more cells that are to apply the one or more restrictions.

In a twenty-second aspect, alone or in combination with one or more of the first through twenty-first aspects, process 1000 includes receiving an indication of a plurality of cells that are configured with the common DRX or DTX cycle and an indication of one or more restrictions to be applied by the plurality of cells that are configured with the common DRX or DTX cycle.

In a twenty-third aspect, alone or in combination with one or more of the first through twenty-second aspects, the DRX or DTX cycle of the network node restricts one or more timers associated with the connected mode DRX or DTX cycle of the UE.

In a twenty-fourth aspect, alone or in combination with one or more of the first through twenty-third aspects, process 1000 includes refraining from communicating with the network node during an active duration of the connected mode DRX or DTX cycle of the UE based at least in part on the active duration of the connected mode DRX or DTX cycle of the UE overlapping with an inactive duration of the DRX or DTX cycle of the network node.

In a twenty-fifth aspect, alone or in combination with one or more of the first through twenty-fourth aspects, the DRX or DTX cycle of the network node indicates to change a timer value for the one or more timers to a default value or indicates a new value for the one or more timers.

In a twenty-sixth aspect, alone or in combination with one or more of the first through twenty-fifth aspects, the UE is configured with one or more default restrictions to be applied to the DRX or DTX cycle of the network node.

In a twenty-seventh aspect, alone or in combination with one or more of the first through twenty-sixth aspects, the one or more default restrictions to be applied to the DRX or DTX cycle of the network node are received via a broadcast transmission.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, by a network node, in accordance with the present disclosure. Example process 1100 is an example where the network node (e.g., network node 110) performs operations associated with network node discontinuous reception and transmission.

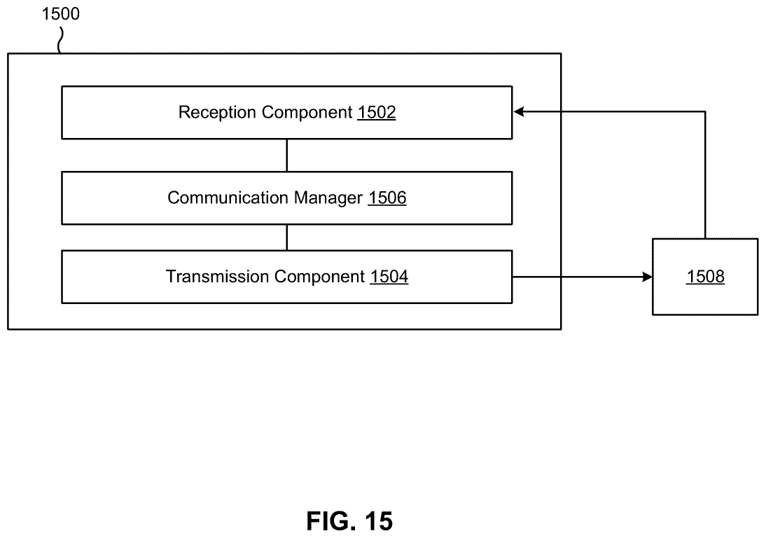

As shown in FIG. 11, in some aspects, process 1100 may include identifying, based at least in part on a connected mode DRX or DTX cycle of a UE, an offset for a DRX or DTX cycle of the network node (block 1110). For example, the network node (e.g., using communication manager 1506, depicted in FIG. 15) may identify, based at least in part on a connected mode DRX or DTX cycle of a UE, an offset for a DRX or DTX cycle of the network node, as described above.

As further shown in FIG. 11, in some aspects, process 1100 may include communicating with the UE in accordance with the DRX or DTX cycle of the network node and the offset for the DRX or DTX cycle of the network node (block 1120). For example, the network node (e.g., using reception component 1502, transmission component 1504, and/or communication manager 1506, depicted in FIG. 15) may communicate with the UE in accordance with the DRX or DTX cycle of the network node and the offset for the DRX or DTX cycle of the network node, as described above.

Process 1100 may include additional aspects, such as any single aspect or any combination of aspects described below and/or in connection with one or more other processes described elsewhere herein.

In a first aspect, the DRX or DTX cycle of the network node is associated with the connected mode DRX or DTX cycle of the UE.

In a second aspect, alone or in combination with the first aspect, an inactive duration of the DRX or DTX cycle of the network node overlaps with at least a portion of an inactive duration of the connected mode DRX or DTX cycle of the UE.

In a third aspect, alone or in combination with one or more of the first and second aspects, the offset corresponds to a time period that is between an end of the inactive duration of the DRX or DTX cycle of the network node and a start of an active duration of the connected mode DRX or DTX cycle of the UE.

In a fourth aspect, alone or in combination with one or more of the first through third aspects, the DRX or DTX cycle of the network node includes one or more restrictions to be applied to the connected mode DRX or DTX cycle of the UE.

In a fifth aspect, alone or in combination with one or more of the first through fourth aspects, an inactive duration of the DRX or DTX cycle of the network node is within an inactive duration of the connected mode DRX or DTX cycle of the UE.

In a sixth aspect, alone or in combination with one or more of the first through fifth aspects, identifying the offset for the DRX or DTX cycle of the network node comprises identifying the offset and at least one of a duration or a periodicity for the DRX or DTX cycle of the network node.

In a seventh aspect, alone or in combination with one or more of the first through sixth aspects, the offset is based at least in part on the duration or the periodicity for the DRX or DTX cycle of the network node or based at least in part on an active duration of the connected mode DRX or DTX cycle of the UE, wherein the duration for the DRX or DTX cycle of the network node is less than an inactive duration of the connected mode DRX or DTX cycle of the UE, and wherein the periodicity for the DRX or DTX cycle of the network node is equal to a periodicity of the connected mode DRX or DTX cycle of the UE or is an integer multiple of the periodicity of the connected mode DRX or DTX cycle of the UE.

In an eighth aspect, alone or in combination with one or more of the first through seventh aspects, the network node is associated with a cell group that includes a plurality of cells, and each cell of the plurality of cells is configured with a plurality of connected mode DRX or DTX cycle configurations.

In a ninth aspect, alone or in combination with one or more of the first through eighth aspects, each cell of the plurality of cells is configured with a same parameter to be applied to the plurality of connected mode DRX or DTX cycle configurations.

In a tenth aspect, alone or in combination with one or more of the first through ninth aspects, a first cell of the plurality of cells is configured with a first parameter to be applied to the plurality of connected mode DRX or DTX cycle configurations and a second cell of the plurality of cells is configured with a second parameter to be applied to the plurality of connected mode DRX or DTX cycle configurations.

In an eleventh aspect, alone or in combination with one or more of the first through tenth aspects, process 1100 includes transmitting radio resource control configuration information that indicates a plurality of candidate restrictions and a plurality of candidate cells associated with the DRX or DTX cycle of the network node.

In a twelfth aspect, alone or in combination with one or more of the first through eleventh aspects, L1 or L2 information is used to indicate a restriction, from the plurality of candidate restrictions, to be applied to the DRX or DTX cycle of the network node, or to indicate a cell, of the plurality of candidate cells, for which the restriction is to be applied.

In a thirteenth aspect, alone or in combination with one or more of the first through twelfth aspects, the restriction applies to one or more resources of a plurality of resources associated with the DRX or DTX cycle of the network node.

In a fourteenth aspect, alone or in combination with one or more of the first through thirteenth aspects, process 1100 includes transmitting radio resource control configuration information that indicates a plurality of parameters associated with the DRX or DTX cycle of the network node, and L1 or L2 information indicates a parameter of the plurality of parameters to be applied to the DRX or DTX cycle of the network node.

In a fifteenth aspect, alone or in combination with one or more of the first through fourteenth aspects, the L1 or L2 information is specific to a cell of a plurality of cells that transmit the L1 or L2 information.

In a sixteenth aspect, alone or in combination with one or more of the first through fifteenth aspects, the L1 or L2 information is configured to be applied by a plurality of cells that transmit the L1 or L2 information.

In a seventeenth aspect, alone or in combination with one or more of the first through sixteenth aspects, process 1100 includes transmitting an indication of a plurality of resources to be used for monitoring for a random access response message after a random access channel MSG1 and during a random access response window, wherein one or more resources of the plurality of resources are within an inactive duration of the DRX or DTX cycle of the network node.

In an eighteenth aspect, alone or in combination with one or more of the first through seventeenth aspects, process 1100 includes transmitting an indication to refrain from monitoring the one or more resources that are within the inactive duration of the DRX or DTX cycle of the network node, wherein the indication to refrain from monitoring the one or more resources that are within the inactive duration of the DRX or DTX cycle of the network node is included in a DRX or DTX cycle configuration or a physical downlink control channel message.

In a nineteenth aspect, alone or in combination with one or more of the first through eighteenth aspects, process 1100 includes transmitting an indication of one or more rules for refraining from monitoring the one or more resources that are within the inactive duration of the DRX or DTX cycle of the network node.

In a twentieth aspect, alone or in combination with one or more of the first through nineteenth aspects, process 1100 includes transmitting an indication of a DRX or DTX cycle of a neighbor cell, wherein the neighbor cell is within a distance of the network node that is less than a distance threshold.

In a twenty-first aspect, alone or in combination with one or more of the first through twentieth aspects, the DRX or DTX cycle of the neighbor cell is a common DRX or DTX cycle that is shared by the network node and the neighbor cell or by the neighbor cell and a serving cell.

In a twenty-second aspect, alone or in combination with one or more of the first through twenty-first aspects, process 1100 includes transmitting an indication of one or more restrictions associated with the common DRX or DTX cycle, wherein the indication of the one or more restrictions indicates one or more cells that are to apply the one or more restrictions.

In a twenty-third aspect, alone or in combination with one or more of the first through twenty-second aspects, process 1100 includes transmitting an indication of a plurality of cells that are configured with the common DRX or DTX cycle and an indication of one or more restrictions to be applied by the plurality of cells that are configured with the common DRX or DTX cycle.

In a twenty-fourth aspect, alone or in combination with one or more of the first through twenty-third aspects, the DRX or DTX cycle of the network node restricts one or more timers associated with the connected mode DRX or DTX cycle of the UE.

In a twenty-fifth aspect, alone or in combination with one or more of the first through twenty-fourth aspects, the DRX or DTX cycle of the network node indicates to change a timer value for the one or more timers to a default value or indicates a new value for the one or more timers.

In a twenty-sixth aspect, alone or in combination with one or more of the first through twenty-fifth aspects, the network node is configured with one or more default restrictions to be applied to the DRX or DTX cycle of the network node.

In a twenty-seventh aspect, alone or in combination with one or more of the first through twenty-sixth aspects, the one or more default restrictions to be applied to the DRX or DTX cycle of the network node are received via a broadcast transmission.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram illustrating an example process 1200 performed, for example, by a UE, in accordance with the present disclosure. Example process 1200 is an example where the UE (e.g., UE 120) performs operations associated with network node discontinuous reception and transmission.

As shown in FIG. 12, in some aspects, process 1200 may include receiving an indication of a DRX or DTX cycle of a network node (block 1210). For example, the UE (e.g., using reception component 1402 and/or communication manager 1406, depicted in FIG. 14) may receive an indication of a DRX or DTX cycle of a network node, as described above.

As further shown in FIG. 12, in some aspects, process 1200 may include communicating with the network node based at least in part on switching between a connected mode DRX or DTX cycle of the UE and the DRX or DTX cycle of the network node (block 1220). For example, the UE (e.g., using reception component 1402, transmission component 1404, and/or communication manager 1406, depicted in FIG. 14) may communicate with the network node based at least in part on switching between a connected mode DRX or DTX cycle of the UE and the DRX or DTX cycle of the network node, as described above.

Process 1200 may include additional aspects, such as any single aspect or any combination of aspects described below and/or in connection with one or more other processes described elsewhere herein.

In a first aspect, only one of the connected mode DRX or DTX cycle of the UE, or the DRX or DTX cycle of the network node, is active at a particular time.

In a second aspect, alone or in combination with the first aspect, the DRX or DTX cycle of the network node is based at least in part on the connected mode DRX or DTX cycle of the UE.

In a third aspect, alone or in combination with one or more of the first and second aspects, the DRX or DTX cycle of the network node includes one or more rules, one or more timers, one or more downlink restrictions, one or more uplink restrictions, or one or more dynamic adaptation rules associated with the connected mode DRX or DTX cycle of the UE.

In a fourth aspect, alone or in combination with one or more of the first through third aspects, process 1200 includes receiving Layer 1 or Layer 2 information that indicates for the UE to switch between the connected mode DRX or DTX cycle of the UE and the DRX or DTX cycle of the network node.

In a fifth aspect, alone or in combination with one or more of the first through fourth aspects, receiving the indication of the DRX or DTX cycle of the network node comprises receiving one or more of an offset, a duration, or a periodicity for the DRX or DTX cycle of the network node.

In a sixth aspect, alone or in combination with one or more of the first through fifth aspects, the UE is configured with one or more default values corresponding to an offset, a duration, or a periodicity for the DRX or DTX cycle of the network node.

In a seventh aspect, alone or in combination with one or more of the first through sixth aspects, process 1200 includes receiving radio resource control configuration information that indicates a plurality of candidate restrictions and a plurality of candidate cells associated with the DRX or DTX cycle of the network node.

In an eighth aspect, alone or in combination with one or more of the first through seventh aspects, L1 or L2 information is used to indicate a restriction, from the plurality of candidate restrictions, to be applied to the DRX or DTX cycle of the network node, or to indicate a cell, of the plurality of candidate cells, for which the restriction is to be applied.

In a ninth aspect, alone or in combination with one or more of the first through eighth aspects, the restriction applies to one or more resources of a plurality of resources associated with the DRX or DTX cycle of the network node.

In a tenth aspect, alone or in combination with one or more of the first through ninth aspects, process 1200 includes receiving radio resource control configuration information that indicates a plurality of parameters associated with the DRX or DTX cycle of the network node, and L1 or L2 information indicates a parameter of the plurality of parameters to be applied to the DRX or DTX cycle of the network node.

In an eleventh aspect, alone or in combination with one or more of the first through tenth aspects, the L1 or L2 information is specific to a cell of a plurality of cells that transmit the L1 or L2 information.

In a twelfth aspect, alone or in combination with one or more of the first through eleventh aspects, the L1 or L2 information is configured to be applied by a plurality of cells that transmit the L1 or L2 information.

In a thirteenth aspect, alone or in combination with one or more of the first through twelfth aspects, process 1200 includes receiving an indication of a plurality of resources to be used for monitoring for a random access response message after a random access channel MSG1 and during a random access response window, wherein one or more resources of the plurality of resources are within an inactive duration of the DRX or DTX cycle of the network node.

In a fourteenth aspect, alone or in combination with one or more of the first through thirteenth aspects, process 1200 includes receiving an indication to refrain from monitoring the one or more resources that are within the inactive duration of the DRX or DTX cycle of the network node, wherein the indication to refrain from monitoring the one or more resources that are within the inactive duration of the DRX or DTX cycle of the network node is included in a DRX or DTX cycle configuration or a physical downlink control channel message.

In a fifteenth aspect, alone or in combination with one or more of the first through fourteenth aspects, process 1200 includes refraining from monitoring the one or more resources that are within the inactive duration of the DRX or DTX cycle of the network node based at least in part on receiving the indication to refrain from monitoring the one or more resources that are within the inactive duration of the DRX or DTX cycle of the network node.

In a sixteenth aspect, alone or in combination with one or more of the first through fifteenth aspects, process 1200 includes receiving an indication of one or more rules for refraining from monitoring the one or more resources that are within the inactive duration of the DRX or DTX cycle of the network node.

In a seventeenth aspect, alone or in combination with one or more of the first through sixteenth aspects, process 1200 includes receiving an indication of a DRX or DTX cycle of a neighbor cell of the network node, wherein the neighbor cell is within a distance of the network node that is less than a distance threshold.

In an eighteenth aspect, alone or in combination with one or more of the first through seventeenth aspects, the DRX or DTX cycle of the neighbor cell is a common DRX or DTX cycle that is shared by the network node and the neighbor cell or by the neighbor cell and a serving cell.

In a nineteenth aspect, alone or in combination with one or more of the first through eighteenth aspects, process 1200 includes receiving an indication of one or more restrictions associated with the common DRX or DTX cycle, wherein the indication of the one or more restrictions indicates one or more cells that are to apply the one or more restrictions.

In a twentieth aspect, alone or in combination with one or more of the first through nineteenth aspects, process 1200 includes receiving an indication of a plurality of cells that are configured with the common DRX or DTX cycle and an indication of one or more restrictions to be applied by the plurality of cells that are configured with the common DRX or DTX cycle.

In a twenty-first aspect, alone or in combination with one or more of the first through twentieth aspects, the DRX or DTX cycle of the network node restricts one or more timers associated with the connected mode DRX or DTX cycle of the UE.

In a twenty-second aspect, alone or in combination with one or more of the first through twenty-first aspects, process 1200 includes refraining from communicating with the network node during an active duration of the connected mode DRX or DTX cycle of the UE based at least in part on the active duration of the connected mode DRX or DTX cycle of the UE overlapping with an inactive duration of the DRX or DTX cycle of the network node.

In a twenty-third aspect, alone or in combination with one or more of the first through twenty-second aspects, the DRX or DTX cycle of the network node indicates to change a timer value for the one or more timers to a default value or indicates a new value for the one or more timers.

In a twenty-fourth aspect, alone or in combination with one or more of the first through twenty-third aspects, the UE is configured with one or more default restrictions to be applied to the DRX or DTX cycle of the network node.

In a twenty-fifth aspect, alone or in combination with one or more of the first through twenty-fourth aspects, the one or more default restrictions to be applied to the DRX or DTX cycle of the network node are received via a broadcast transmission.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram illustrating an example process 1300 performed, for example, by a network node, in accordance with the present disclosure. Example process 1300 is an example where the network node (e.g., network node 110) performs operations associated with network node discontinuous reception and transmission.

As shown in FIG. 13, in some aspects, process 1300 may include transmitting an indication of a DRX or DTX cycle of the network node (block 1310). For example, the network node (e.g., using transmission component 1504 and/or communication manager 1506, depicted in FIG. 15) may transmit an indication of a DRX or DTX cycle of the network node, as described above.

As further shown in FIG. 13, in some aspects, process 1300 may include communicating with a UE based at least in part on switching between a connected mode DRX or DTX cycle of the UE and the DRX or DTX cycle of the network node (block 1320). For example, the network node (e.g., using reception component 1502, transmission component 1504, and/or communication manager 1506, depicted in FIG. 15) may communicate with a UE based at least in part on switching between a connected mode DRX or DTX cycle of the UE and the DRX or DTX cycle of the network node, as described above.

Process 1300 may include additional aspects, such as any single aspect or any combination of aspects described below and/or in connection with one or more other processes described elsewhere herein.

In a first aspect, only one of the connected mode DRX or DTX cycle of the UE, or the DRX or DTX cycle of the network node, is active at a particular time.

In a second aspect, alone or in combination with the first aspect, the DRX or DTX cycle of the network node is based at least in part on the connected mode DRX or DTX cycle of the UE.

In a third aspect, alone or in combination with one or more of the first and second aspects, the DRX or DTX cycle of the network node includes one or more rules, one or more timers, one or more downlink restrictions, one or more uplink restrictions, or one or more dynamic adaptation rules associated with the connected mode DRX or DTX cycle of the UE.

In a fourth aspect, alone or in combination with one or more of the first through third aspects, process 1300 includes transmitting Layer 1 or Layer 2 information that indicates for the UE to switch between the connected mode DRX or DTX cycle of the UE and the DRX or DTX cycle of the network node.

In a fifth aspect, alone or in combination with one or more of the first through fourth aspects, transmitting the indication of the DRX or DTX cycle of the network node comprises transmitting one or more of an offset, a duration, or a periodicity for the DRX or DTX cycle of the network node.

In a sixth aspect, alone or in combination with one or more of the first through fifth aspects, the network node is configured with one or more default values corresponding to an offset, a duration, or a periodicity for the DRX or DTX cycle of the network node.

In a seventh aspect, alone or in combination with one or more of the first through sixth aspects, process 1300 includes transmitting radio resource control configuration information that indicates a plurality of candidate restrictions and a plurality of candidate cells associated with the DRX or DTX cycle of the network node.

In an eighth aspect, alone or in combination with one or more of the first through seventh aspects, Layer 1 or Layer 2 information is used to indicate a restriction, from the plurality of candidate restrictions, to be applied to the DRX or DTX cycle of the network node, or to indicate a cell, of the plurality of candidate cells, for which the restriction is to be applied.

In a ninth aspect, alone or in combination with one or more of the first through eighth aspects, the restriction applies to one or more resources of a plurality of resources associated with the DRX or DTX cycle of the network node.

In a tenth aspect, alone or in combination with one or more of the first through ninth aspects, process 1300 includes transmitting radio resource control configuration information that indicates a plurality of parameters associated with the DRX or DTX cycle of the network node, and the L1 or L2 information indicates a parameter of the plurality of parameters to be applied to the DRX or DTX cycle of the network node.

In an eleventh aspect, alone or in combination with one or more of the first through tenth aspects, the L1 or L2 information is specific to a cell of a plurality of cells that transmit the L1 or L2 information.

In a twelfth aspect, alone or in combination with one or more of the first through eleventh aspects, the L1 or L2 information is configured to be applied by a plurality of cells that transmit the L1 or L2 information.

In a thirteenth aspect, alone or in combination with one or more of the first through twelfth aspects, process 1300 includes transmitting an indication of a plurality of resources to be used for monitoring for a random access response message after a random access channel MSG1 and during a random access response window, wherein one or more resources of the plurality of resources are within an inactive duration of the DRX or DTX cycle of the network node.

In a fourteenth aspect, alone or in combination with one or more of the first through thirteenth aspects, process 1300 includes transmitting an indication to refrain from monitoring the one or more resources that are within the inactive duration of the DRX or DTX cycle of the network node, wherein the indication to refrain from monitoring the one or more resources that are within the inactive duration of the DRX or DTX cycle of the network node is included in a DRX or DTX cycle configuration or a physical downlink control channel message.

In a fifteenth aspect, alone or in combination with one or more of the first through fourteenth aspects, process 1300 includes transmitting an indication of one or more rules for refraining from monitoring the one or more resources that are within the inactive duration of the DRX or DTX cycle of the network node.

In a sixteenth aspect, alone or in combination with one or more of the first through fifteenth aspects, process 1300 includes transmitting an indication of a DRX or DTX cycle of a neighbor cell, wherein the neighbor cell is within a distance of the network node that is less than a distance threshold.

In a seventeenth aspect, alone or in combination with one or more of the first through sixteenth aspects, the DRX or DTX cycle of the neighbor cell is a common DRX or DTX cycle that is shared by the network node and the neighbor cell or by the neighbor cell and a serving cell.

In an eighteenth aspect, alone or in combination with one or more of the first through seventeenth aspects, process 1300 includes transmitting an indication of one or more restrictions associated with the common DRX or DTX cycle, wherein the indication of the one or more restrictions indicates one or more cells that are to apply the one or more restrictions.

In a nineteenth aspect, alone or in combination with one or more of the first through eighteenth aspects, process 1300 includes transmitting an indication of a plurality of cells that are configured with the common DRX or DTX cycle and an indication of one or more restrictions to be applied by the plurality of cells that are configured with the common DRX or DTX cycle.

In a twentieth aspect, alone or in combination with one or more of the first through nineteenth aspects, the network node is configured with one or more default restrictions to be applied to the DRX or DTX cycle of the network node.

In a twenty-first aspect, alone or in combination with one or more of the first through twentieth aspects, the one or more default restrictions to be applied to the DRX or DTX cycle of the network node are received via a broadcast transmission.

Although FIG. 13 shows example blocks of process 1300, in some aspects, process 1300 may include additional blocks, fewer blocks, different blocks, or differently arranged blocks than those depicted in FIG. 13. Additionally, or alternatively, two or more of the blocks of process 1300 may be performed in parallel.

FIG. 14 is a diagram of an example apparatus 1400 for wireless communication, in accordance with the present disclosure. The apparatus 1400 may be a UE, or a UE may include the apparatus 1400. In some aspects, the apparatus 1400 includes a reception component 1402, a transmission component 1404, and/or a communication manager 1406, which may be in communication with one another (for example, via one or more buses and/or one or more other components). In some aspects, the communication manager 1406 is the communication manager 140 described in connection with FIG. 1. As shown, the apparatus 1400 may communicate with another apparatus 1408, such as a UE or a network node (such as a CU, a DU, an RU, or a base station), using the reception component 1402 and the transmission component 1404.

In some aspects, the apparatus 1400 may be configured to perform one or more operations described herein in connection with FIGS. 5-9. Additionally, or alternatively, the apparatus 1400 may be configured to perform one or more processes described herein, such as process 1000 of FIG. 10, process 1200 of FIG. 12, or a combination thereof. In some aspects, the apparatus 1400 and/or one or more components shown in FIG. 14 may include one or more components of the UE described in connection with FIG. 2. Additionally, or alternatively, one or more components shown in FIG. 14 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1402 may receive communications, such as reference signals, control information, data communications, or a combination thereof, from the apparatus 1408. The reception component 1402 may provide received communications to one or more other components of the apparatus 1400. In some aspects, the reception component 1402 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1400. In some aspects, the reception component 1402 may include one or more antennas, a modem, a demodulator, a MIMO detector, a receive processor, a controller/processor, a memory, or a combination thereof, of the UE described in connection with FIG. 2.

The transmission component 1404 may transmit communications, such as reference signals, control information, data communications, or a combination thereof, to the apparatus 1408. In some aspects, one or more other components of the apparatus 1400 may generate communications and may provide the generated communications to the transmission component 1404 for transmission to the apparatus 1408. In some aspects, the transmission component 1404 may perform signal processing on the generated communications (such as filtering, amplification, modulation, digital-to-analog conversion, multiplexing, interleaving, mapping, or encoding, among other examples), and may transmit the processed signals to the apparatus 1408. In some aspects, the transmission component 1404 may include one or more antennas, a modem, a modulator, a transmit MIMO processor, a transmit processor, a controller/processor, a memory, or a combination thereof, of the UE described in connection with FIG. 2. In some aspects, the transmission component 1404 may be co-located with the reception component 1402 in a transceiver.

The communication manager 1406 may support operations of the reception component 1402 and/or the transmission component 1404. For example, the communication manager 1406 may receive information associated with configuring reception of communications by the reception component 1402 and/or transmission of communications by the transmission component 1404. Additionally, or alternatively, the communication manager 1406 may generate and/or provide control information to the reception component 1402 and/or the transmission component 1404 to control reception and/or transmission of communications.

The reception component 1402 may receive an offset for a DRX or DTX cycle of a network node, the offset being based at least in part on a connected mode DRX or DTX cycle of the UE. The reception component 1402 and/or the transmission component 1404 may communicate with the network node in accordance with the DRX or DTX cycle of the network node and the offset for the DRX or DTX cycle of the network node.

The reception component 1402 may receive radio resource control configuration information that indicates a plurality of candidate restrictions and a plurality of candidate cells associated with the DRX or DTX cycle of the network node.

The reception component 1402 may receive radio resource control configuration information that indicates a plurality of parameters associated with the DRX or DTX cycle of the network node, and L1 or L2 information indicates a parameter of the plurality of parameters to be applied to the DRX or DTX cycle of the network node.

The reception component 1402 may receive an indication of a plurality of resources to be used for monitoring for a random access response message after a random access channel MSG1 and during a random access response window, wherein one or more resources of the plurality of resources are within an inactive duration of the DRX or DTX cycle of the network node.

The reception component 1402 may receive an indication to refrain from monitoring the one or more resources that are within the inactive duration of the DRX or DTX cycle of the network node, wherein the indication to refrain from monitoring the one or more resources that are within the inactive duration of the DRX or DTX cycle of the network node is included in a DRX or DTX cycle configuration or a physical downlink control channel message.

The communication manager 1406 may refrain from monitoring the one or more resources that are within the inactive duration of the DRX or DTX cycle of the network node based at least in part on receiving the indication to refrain from monitoring the one or more resources that are within the inactive duration of the DRX or DTX cycle of the network node.

The reception component 1402 may receive an indication of one or more rules for refraining from monitoring the one or more resources that are within the inactive duration of the DRX or DTX cycle of the network node.

The reception component 1402 may receive an indication of a DRX or DTX cycle of a neighbor cell of the network node, wherein the neighbor cell is within a distance of the network node that is less than a distance threshold.

The reception component 1402 may receive an indication of one or more restrictions associated with the common DRX or DTX cycle, wherein the indication of the one or more restrictions indicates one or more cells that are to apply the one or more restrictions.

The reception component 1402 may receive an indication of a plurality of cells that are configured with the common DRX or DTX cycle and an indication of one or more restrictions to be applied by the plurality of cells that are configured with the common DRX or DTX cycle.

The communication manager 1406 may refrain from communicating with the network node during an active duration of the connected mode DRX or DTX cycle of the UE based at least in part on the active duration of the connected mode DRX or DTX cycle of the UE overlapping with an inactive duration of the DRX or DTX cycle of the network node.

The reception component 1402 may receive an indication of a DRX or DTX cycle of a network node. The reception component 1402 and/or the transmission component 1404 may communicate with the network node based at least in part on switching between a connected mode DRX or DTX cycle of the UE and the DRX or DTX cycle of the network node.

The reception component 1402 may receive L1 or L2 information that indicates for the UE to switch between the connected mode DRX or DTX cycle of the UE and the DRX or DTX cycle of the network node.

The reception component 1402 may receive radio resource control configuration information that indicates a plurality of candidate restrictions and a plurality of candidate cells associated with the DRX or DTX cycle of the network node.

The reception component 1402 may receive radio resource control configuration information that indicates a plurality of parameters associated with the DRX or DTX cycle of the network node, and L1 or L2 information indicates a parameter of the plurality of parameters to be applied to the DRX or DTX cycle of the network node.

The reception component 1402 may receive an indication of a plurality of resources to be used for monitoring for a random access response message after a random access channel MSG1 and during a random access response window, wherein one or more resources of the plurality of resources are within an inactive duration of the DRX or DTX cycle of the network node.

The reception component 1402 may receive an indication to refrain from monitoring the one or more resources that are within the inactive duration of the DRX or DTX cycle of the network node, wherein the indication to refrain from monitoring the one or more resources that are within the inactive duration of the DRX or DTX cycle of the network node is included in a DRX or DTX cycle configuration or a physical downlink control channel message.

The communication manager 1406 may refrain from monitoring the one or more resources that are within the inactive duration of the DRX or DTX cycle of the network node based at least in part on receiving the indication to refrain from monitoring the one or more resources that are within the inactive duration of the DRX or DTX cycle of the network node.

The reception component 1402 may receive an indication of one or more rules for refraining from monitoring the one or more resources that are within the inactive duration of the DRX or DTX cycle of the network node.

The reception component 1402 may receive an indication of a DRX or DTX cycle of a neighbor cell of the network node, wherein the neighbor cell is within a distance of the network node that is less than a distance threshold.

The reception component 1402 may receive an indication of one or more restrictions associated with the common DRX or DTX cycle, wherein the indication of the one or more restrictions indicates one or more cells that are to apply the one or more restrictions.

The reception component 1402 may receive an indication of a plurality of cells that are configured with the common DRX or DTX cycle and an indication of one or more restrictions to be applied by the plurality of cells that are configured with the common DRX or DTX cycle.

The communication manager 1406 may refrain from communicating with the network node during an active duration of the connected mode DRX or DTX cycle of the UE based at least in part on the active duration of the connected mode DRX or DTX cycle of the UE overlapping with an inactive duration of the DRX or DTX cycle of the network node.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally, or alternatively, a set of (one or more) components shown in FIG. 14 may perform one or more functions described as being performed by another set of components shown in FIG. 14.

FIG. 15 is a diagram of an example apparatus 1500 for wireless communication, in accordance with the present disclosure. The apparatus 1500 may be a network node, or a network node may include the apparatus 1500. In some aspects, the apparatus 1500 includes a reception component 1502, a transmission component 1504, and/or a communication manager 1506, which may be in communication with one another (for example, via one or more buses and/or one or more other components). In some aspects, the communication manager 1506 is the communication manager 150 described in connection with FIG. 1. As shown, the apparatus 1500 may communicate with another apparatus 1508, such as a UE or a network node (such as a CU, a DU, an RU, or a base station), using the reception component 1502 and the transmission component 1504.

In some aspects, the apparatus 1500 may be configured to perform one or more operations described herein in connection with FIGS. 5-9. Additionally, or alternatively, the apparatus 1500 may be configured to perform one or more processes described herein, such as process 1100 of FIG. 11, process 1300 of FIG. 13, or a combination thereof. In some aspects, the apparatus 1500 and/or one or more components shown in FIG. 15 may include one or more components of the network node described in connection with FIG. 2. Additionally, or alternatively, one or more components shown in FIG. 15 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1502 may receive communications, such as reference signals, control information, data communications, or a combination thereof, from the apparatus 1508. The reception component 1502 may provide received communications to one or more other components of the apparatus 1500. In some aspects, the reception component 1502 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1500. In some aspects, the reception component 1502 may include one or more antennas, a modem, a demodulator, a MIMO detector, a receive processor, a controller/processor, a memory, or a combination thereof, of the network node described in connection with FIG. 2. In some aspects, the reception component 1502 and/or the transmission component 1504 may include or may be included in a network interface. The network interface may be configured to obtain and/or output signals for the apparatus 1500 via one or more communications links, such as a backhaul link, a midhaul link, and/or a fronthaul link.

The transmission component 1504 may transmit communications, such as reference signals, control information, data communications, or a combination thereof, to the apparatus 1508. In some aspects, one or more other components of the apparatus 1500 may generate communications and may provide the generated communications to the transmission component 1504 for transmission to the apparatus 1508. In some aspects, the transmission component 1504 may perform signal processing on the generated communications (such as filtering, amplification, modulation, digital-to-analog conversion, multiplexing, interleaving, mapping, or encoding, among other examples), and may transmit the processed signals to the apparatus 1508. In some aspects, the transmission component 1504 may include one or more antennas, a modem, a modulator, a transmit MIMO processor, a transmit processor, a controller/processor, a memory, or a combination thereof, of the network node described in connection with FIG. 2. In some aspects, the transmission component 1504 may be co-located with the reception component 1502 in a transceiver.

The communication manager 1506 may support operations of the reception component 1502 and/or the transmission component 1504. For example, the communication manager 1506 may receive information associated with configuring reception of communications by the reception component 1502 and/or transmission of communications by the transmission component 1504. Additionally, or alternatively, the communication manager 1506 may generate and/or provide control information to the reception component 1502 and/or the transmission component 1504 to control reception and/or transmission of communications.

The communication manager 1506 may identify, based at least in part on a connected mode DRX or DTX cycle of a UE, an offset for a DRX or DTX cycle of the network node. The reception component 1502 and/or the transmission component 1504 may communicate with the UE in accordance with the DRX or DTX cycle of the network node and the offset for the DRX or DTX cycle of the network node.

The transmission component 1504 may transmit radio resource control configuration information that indicates a plurality of candidate restrictions and a plurality of candidate cells associated with the DRX or DTX cycle of the network node.

The transmission component 1504 may transmit radio resource control configuration information that indicates a plurality of parameters associated with the DRX or DTX cycle of the network node, and L1 or L2 information indicates a parameter of the plurality of parameters to be applied to the DRX or DTX cycle of the network node.

The transmission component 1504 may transmit an indication of a plurality of resources to be used for monitoring for a random access response message after a random access channel MSG1 and during a random access response window, wherein one or more resources of the plurality of resources are within an inactive duration of the DRX or DTX cycle of the network node.

The transmission component 1504 may transmit an indication to refrain from monitoring the one or more resources that are within the inactive duration of the DRX or DTX cycle of the network node, wherein the indication to refrain from monitoring the one or more resources that are within the inactive duration of the DRX or DTX cycle of the network node is included in a DRX or DTX cycle configuration or a physical downlink control channel message.

The transmission component 1504 may transmit an indication of one or more rules for refraining from monitoring the one or more resources that are within the inactive duration of the DRX or DTX cycle of the network node.

The transmission component 1504 may transmit an indication of a DRX or DTX cycle of a neighbor cell, wherein the neighbor cell is within a distance of the network node that is less than a distance threshold.

The transmission component 1504 may transmit an indication of one or more restrictions associated with the common DRX or DTX cycle, wherein the indication of the one or more restrictions indicates one or more cells that are to apply the one or more restrictions.

The transmission component 1504 may transmit an indication of a plurality of cells that are configured with the common DRX or DTX cycle and an indication of one or more restrictions to be applied by the plurality of cells that are configured with the common DRX or DTX cycle.

The transmission component 1504 may transmit an indication of a DRX or DTX cycle of the network node. The reception component 1502 and/or the transmission component 1504 may communicate with a UE based at least in part on switching between a connected mode DRX or DTX cycle of the UE and the DRX or DTX cycle of the network node.

The transmission component 1504 may transmit L1 or L2 information that indicates for the UE to switch between the connected mode DRX or DTX cycle of the UE and the DRX or DTX cycle of the network node.

The transmission component 1504 may transmit radio resource control configuration information that indicates a plurality of candidate restrictions and a plurality of candidate cells associated with the DRX or DTX cycle of the network node.

The transmission component 1504 may transmit radio resource control configuration information that indicates a plurality of parameters associated with the DRX or DTX cycle of the network node, and L1 or L2 information indicates a parameter of the plurality of parameters to be applied to the DRX or DTX cycle of the network node.

The transmission component 1504 may transmit an indication of a plurality of resources to be used for monitoring for a random access response message after a random access channel MSG1 and during a random access response window, wherein one or more resources of the plurality of resources are within an inactive duration of the DRX or DTX cycle of the network node.

The transmission component 1504 may transmit an indication to refrain from monitoring the one or more resources that are within the inactive duration of the DRX or DTX cycle of the network node, wherein the indication to refrain from monitoring the one or more resources that are within the inactive duration of the DRX or DTX cycle of the network node is included in a DRX or DTX cycle configuration or a physical downlink control channel message.

The transmission component 1504 may transmit an indication of one or more rules for refraining from monitoring the one or more resources that are within the inactive duration of the DRX or DTX cycle of the network node.

The transmission component 1504 may transmit an indication of a DRX or DTX cycle of a neighbor cell, wherein the neighbor cell is within a distance of the network node that is less than a distance threshold.

The transmission component 1504 may transmit an indication of one or more restrictions associated with the common DRX or DTX cycle, wherein the indication of the one or more restrictions indicates one or more cells that are to apply the one or more restrictions.

The transmission component 1504 may transmit an indication of a plurality of cells that are configured with the common DRX or DTX cycle and an indication of one or more restrictions to be applied by the plurality of cells that are configured with the common DRX or DTX cycle.

The number and arrangement of components shown in FIG. 15 are provided as an example. In practice, there may be additional components, fewer components, different components, or differently arranged components than those shown in FIG. 15. Furthermore, two or more components shown in FIG. 15 may be implemented within a single component, or a single component shown in FIG. 15 may be implemented as multiple, distributed components. Additionally, or alternatively, a set of (one or more) components shown in FIG. 15 may perform one or more functions described as being performed by another set of components shown in FIG. 15.

The following provides an overview of some Aspects of the present disclosure:

Aspect 1: A method of wireless communication performed by a user equipment (UE), comprising: receiving an offset for a discontinuous reception (DRX) or discontinuous transmission (DTX) cycle of a network node, the offset being based at least in part on a connected mode DRX or DTX cycle of the UE; and communicating with the network node in accordance with the DRX or DTX cycle of the network node and the offset for the DRX or DTX cycle of the network node.

Aspect 2: The method of Aspect 1, wherein the DRX or DTX cycle of the network node is associated with the connected mode DRX or DTX cycle of the UE.

Aspect 3: The method of Aspect 2, wherein an inactive duration of the DRX or DTX cycle of the network node overlaps with at least a portion of an inactive duration of the connected mode DRX or DTX cycle of the UE.

Aspect 4: The method of Aspect 3, wherein the offset corresponds to a time period that is between an end of the inactive duration of the DRX or DTX cycle of the network node and a start of an active duration of the connected mode DRX or DTX cycle of the UE.

Aspect 5: The method of any of Aspects 1-4, wherein the DRX or DTX cycle of the network node includes one or more restrictions to be applied to the connected mode DRX or DTX cycle of the UE.

Aspect 6: The method of Aspect 5, wherein an inactive duration of the DRX or DTX cycle of the network node is within an inactive duration of the connected mode DRX or DTX cycle of the UE.

Aspect 7: The method of Aspect 5, wherein communicating with the network node comprises communicating with the network node during an active duration of the connected mode DRX or DTX cycle of the UE based at least in part on an inactive duration of the DRX or DTX cycle of the network node overlapping with the active duration of the connected mode DRX or DTX cycle of the UE.

Aspect 8: The method of Aspect 5, wherein receiving the offset for the DRX or DTX cycle of the network node comprises receiving the offset and at least one of a duration or a periodicity for the DRX or DTX cycle of the network node.

Aspect 9: The method of Aspect 8, wherein the offset is based at least in part on the duration or the periodicity for the DRX or DTX cycle of the network node or based at least in part on an active duration of the connected mode DRX or DTX cycle of the UE, wherein the duration for the DRX or DTX cycle of the network node is less than an inactive duration of the connected mode DRX or DTX cycle of the UE, and wherein the periodicity for the DRX or DTX cycle of the network node is equal to a periodicity of the connected mode DRX or DTX cycle of the UE or is an integer multiple of the periodicity of the connected mode DRX or DTX cycle of the UE.

Aspect 10: The method of any of Aspects 1-9, further comprising receiving radio resource control configuration information that indicates a plurality of candidate restrictions and a plurality of candidate cells associated with the DRX or DTX cycle of the network node.

Aspect 11: The method of Aspect 10, wherein Layer 1 or Layer 2 information is used to indicate a restriction, from the plurality of candidate restrictions, to be applied to the DRX or DTX cycle of the network node, or to indicate a cell, of the plurality of candidate cells, for which the restriction is to be applied.

Aspect 12: The method of Aspect 11, wherein the restriction applies to one or more resources of a plurality of resources associated with the DRX or DTX cycle of the network node.

Aspect 13: The method of any of Aspects 1-12, further comprising receiving radio resource control configuration information that indicates a plurality of parameters associated with the DRX or DTX cycle of the network node, and wherein Layer 1 (L1) or Layer 2 (L2) information indicates a parameter of the plurality of parameters to be applied to the DRX or DTX cycle of the network node.

Aspect 14: The method of Aspect 13, wherein the L1 or L2 information is specific to a cell of a plurality of cells that transmit the L1 or L2 information.

Aspect 15: The method of Aspect 13, wherein the L1 or L2 information is configured to be applied by a plurality of cells that transmit the L1 or L2 information.

Aspect 16: The method of any of Aspects 1-15, further comprising receiving an indication of a plurality of resources to be used for monitoring for a random access response message after a random access channel Message 1 and during a random access response window, wherein one or more resources of the plurality of resources are within an inactive duration of the DRX or DTX cycle of the network node.

Aspect 17: The method of Aspect 16, further comprising receiving an indication to refrain from monitoring the one or more resources that are within the inactive duration of the DRX or DTX cycle of the network node, wherein the indication to refrain from monitoring the one or more resources that are within the inactive duration of the DRX or DTX cycle of the network node is included in a DRX or DTX cycle configuration or a physical downlink control channel message.

Aspect 18: The method of Aspect 17, further comprising refraining from monitoring the one or more resources that are within the inactive duration of the DRX or DTX cycle of the network node based at least in part on receiving the indication to refrain from monitoring the one or more resources that are within the inactive duration of the DRX or DTX cycle of the network node.

Aspect 19: The method of Aspect 17, further comprising receiving an indication of one or more rules for refraining from monitoring the one or more resources that are within the inactive duration of the DRX or DTX cycle of the network node.

Aspect 20: The method of any of Aspects 1-19, further comprising receiving an indication of a DRX or DTX cycle of a neighbor cell of the network node, wherein the neighbor cell is within a distance of the network node that is less than a distance threshold.

Aspect 21: The method of Aspect 20, wherein the DRX or DTX cycle of the neighbor cell is a common DRX or DTX cycle that is shared by the network node and the neighbor cell or by the neighbor cell and a serving cell.

Aspect 22: The method of Aspect 21, further comprising receiving an indication of one or more restrictions associated with the common DRX or DTX cycle, wherein the indication of the one or more restrictions indicates one or more cells that are to apply the one or more restrictions.

Aspect 23: The method of Aspect 21, further comprising receiving an indication of a plurality of cells that are configured with the common DRX or DTX cycle and an indication of one or more restrictions to be applied by the plurality of cells that are configured with the common DRX or DTX cycle.

Aspect 24: The method of any of Aspects 1-23, wherein the DRX or DTX cycle of the network node restricts one or more timers associated with the connected mode DRX or DTX cycle of the UE.

Aspect 25: The method of Aspect 24, further comprising refraining from communicating with the network node during an active duration of the connected mode DRX or DTX cycle of the UE based at least in part on the active duration of the connected mode DRX or DTX cycle of the UE overlapping with an inactive duration of the DRX or DTX cycle of the network node.

Aspect 26: The method of Aspect 24, wherein the DRX or DTX cycle of the network node indicates to change a timer value for the one or more timers to a default value or indicates a new value for the one or more timers.

Aspect 27: The method of any of Aspects 1-26, wherein the UE is configured with one or more default restrictions to be applied to the DRX or DTX cycle of the network node.

Aspect 28: The method of Aspect 27, wherein the one or more default restrictions to be applied to the DRX or DTX cycle of the network node are received via a broadcast transmission.

Aspect 29: A method of wireless communication performed by a network node, comprising: identifying, based at least in part on a connected mode discontinuous reception (DRX) or discontinuous transmission (DTX) cycle of a user equipment (UE), an offset for a DRX or DTX cycle of the network node; and communicating with the UE in accordance with the DRX or DTX cycle of the network node and the offset for the DRX or DTX cycle of the network node.

Aspect 30: The method of Aspect 29, wherein the DRX or DTX cycle of the network node is associated with the connected mode DRX or DTX cycle of the UE.

Aspect 31: The method of Aspect 30, wherein an inactive duration of the DRX or DTX cycle of the network node overlaps with at least a portion of an inactive duration of the connected mode DRX or DTX cycle of the UE.

Aspect 32: The method of Aspect 31, wherein the offset corresponds to a time period that is between an end of the inactive duration of the DRX or DTX cycle of the network node and a start of an active duration of the connected mode DRX or DTX cycle of the UE.

Aspect 33: The method of any of Aspects 29-32, wherein the DRX or DTX cycle of the network node includes one or more restrictions to be applied to the connected mode DRX or DTX cycle of the UE.

Aspect 34: The method of Aspect 33, wherein an inactive duration of the DRX or DTX cycle of the network node is within an inactive duration of the connected mode DRX or DTX cycle of the UE.

Aspect 35: The method of Aspect 33, wherein identifying the offset for the DRX or DTX cycle of the network node comprises identifying the offset and at least one of a duration or a periodicity for the DRX or DTX cycle of the network node.

Aspect 36: The method of Aspect 35, wherein the offset is based at least in part on the duration or the periodicity for the DRX or DTX cycle of the network node or based at least in part on an active duration of the connected mode DRX or DTX cycle of the UE, wherein the duration for the DRX or DTX cycle of the network node is less than an inactive duration of the connected mode DRX or DTX cycle of the UE, and wherein the periodicity for the DRX or DTX cycle of the network node is equal to a periodicity of the connected mode DRX or DTX cycle of the UE or is an integer multiple of the periodicity of the connected mode DRX or DTX cycle of the UE.

Aspect 37: The method of any of Aspects 29-36, wherein the network node is associated with a cell group that includes a plurality of cells, and wherein each cell of the plurality of cells is configured with a plurality of connected mode DRX or DTX cycle configurations.

Aspect 38: The method of Aspect 37, wherein each cell of the plurality of cells is configured with a same parameter to be applied to the plurality of connected mode DRX or DTX cycle configurations.

Aspect 39: The method of Aspect 37, wherein a first cell of the plurality of cells is configured with a first parameter to be applied to the plurality of connected mode DRX or DTX cycle configurations and a second cell of the plurality of cells is configured with a second parameter to be applied to the plurality of connected mode DRX or DTX cycle configurations.

Aspect 40: The method of any of Aspects 29-39, further comprising transmitting radio resource control configuration information that indicates a plurality of candidate restrictions and a plurality of candidate cells associated with the DRX or DTX cycle of the network node.

Aspect 41: The method of Aspect 40, wherein Layer 1 or Layer 2 information is used to indicate a restriction, from the plurality of candidate restrictions, to be applied to the DRX or DTX cycle of the network node, or to indicate a cell, of the plurality of candidate cells, for which the restriction is to be applied.

Aspect 42: The method of Aspect 41, wherein the restriction applies to one or more resources of a plurality of resources associated with the DRX or DTX cycle of the network node.

Aspect 43: The method of any of Aspects 29-42, further comprising transmitting radio resource control configuration information that indicates a plurality of parameters associated with the DRX or DTX cycle of the network node, and wherein Layer 1 (L1) or Layer 2 (L2) information indicates a parameter of the plurality of parameters to be applied to the DRX or DTX cycle of the network node.

Aspect 44: The method of Aspect 43, wherein the L1 or L2 information is specific to a cell of a plurality of cells that transmit the L1 or L2 information.

Aspect 45: The method of Aspect 43, wherein the L1 or L2 information is configured to be applied by a plurality of cells that transmit the L1 or L2 information.

Aspect 46: The method of any of Aspects 29-45, further comprising transmitting an indication of a plurality of resources to be used for monitoring for a random access response message after a random access channel Message 1 and during a random access response window, wherein one or more resources of the plurality of resources are within an inactive duration of the DRX or DTX cycle of the network node.

Aspect 47: The method of Aspect 46, further comprising transmitting an indication to refrain from monitoring the one or more resources that are within the inactive duration of the DRX or DTX cycle of the network node, wherein the indication to refrain from monitoring the one or more resources that are within the inactive duration of the DRX or DTX cycle of the network node is included in a DRX or DTX cycle configuration or a physical downlink control channel message.

Aspect 48: The method of Aspect 47, further comprising transmitting an indication of one or more rules for refraining from monitoring the one or more resources that are within the inactive duration of the DRX or DTX cycle of the network node.

Aspect 49: The method of any of Aspects 29-48, further comprising transmitting an indication of a DRX or DTX cycle of a neighbor cell, wherein the neighbor cell is within a distance of the network node that is less than a distance threshold.

Aspect 50: The method of Aspect 49, wherein the DRX or DTX cycle of the neighbor cell is a common DRX or DTX cycle that is shared by the network node and the neighbor cell or by the neighbor cell and a serving cell.

Aspect 51: The method of Aspect 50, further comprising transmitting an indication of one or more restrictions associated with the common DRX or DTX cycle, wherein the indication of the one or more restrictions indicates one or more cells that are to apply the one or more restrictions.

Aspect 52: The method of Aspect 50, further comprising transmitting an indication of a plurality of cells that are configured with the common DRX or DTX cycle and an indication of one or more restrictions to be applied by the plurality of cells that are configured with the common DRX or DTX cycle.

Aspect 53: The method of any of Aspects 29-52, wherein the DRX or DTX cycle of the network node restricts one or more timers associated with the connected mode DRX or DTX cycle of the UE.

Aspect 54: The method of Aspect 53, wherein the DRX or DTX cycle of the network node indicates to change a timer value for the one or more timers to a default value or indicates a new value for the one or more timers.

Aspect 55: The method of any of Aspects 29-54, wherein the network node is configured with one or more default restrictions to be applied to the DRX or DTX cycle of the network node.

Aspect 56: The method of Aspect 55, wherein the one or more default restrictions to be applied to the DRX or DTX cycle of the network node are received via a broadcast transmission.

Aspect 57: A method of wireless communication performed by a user equipment (UE), comprising: receiving an indication of a discontinuous reception (DRX) or discontinuous transmission (DTX) cycle of a network node; and communicating with the network node based at least in part on switching between a connected mode DRX or DTX cycle of the UE and the DRX or DTX cycle of the network node.

Aspect 58: The method of Aspect 57, wherein only one of the connected mode DRX or DTX cycle of the UE, or the DRX or DTX cycle of the network node, is active at a particular time.

Aspect 59: The method of any of Aspects 57-58, wherein the DRX or DTX cycle of the network node is based at least in part on the connected mode DRX or DTX cycle of the UE.

Aspect 60: The method of Aspect 59, wherein the DRX or DTX cycle of the network node includes one or more rules, one or more timers, one or more downlink restrictions, one or more uplink restrictions, or one or more dynamic adaptation rules associated with the connected mode DRX or DTX cycle of the UE.

Aspect 61: The method of any of Aspects 57-60, further comprising receiving Layer 1 or Layer 2 information that indicates for the UE to switch between the connected mode DRX or DTX cycle of the UE and the DRX or DTX cycle of the network node.

Aspect 62: The method of any of Aspects 57-61, wherein receiving the indication of the DRX or DTX cycle of the network node comprises receiving one or more of an offset, a duration, or a periodicity for the DRX or DTX cycle of the network node.

Aspect 63: The method of any of Aspects 57-62, wherein the UE is configured with one or more default values corresponding to an offset, a duration, or a periodicity for the DRX or DTX cycle of the network node.

Aspect 64: The method of any of Aspects 57-63, further comprising receiving radio resource control configuration information that indicates a plurality of candidate restrictions and a plurality of candidate cells associated with the DRX or DTX cycle of the network node.

Aspect 65: The method of Aspect 64, wherein Layer 1 or Layer 2 information is used to indicate a restriction, from the plurality of candidate restrictions, to be applied to the DRX or DTX cycle of the network node, or to indicate a cell, of the plurality of candidate cells, for which the restriction is to be applied.

Aspect 66: The method of Aspect 65, wherein the restriction applies to one or more resources of a plurality of resources associated with the DRX or DTX cycle of the network node.

Aspect 67: The method of any of Aspects 57-66, further comprising receiving radio resource control configuration information that indicates a plurality of parameters associated with the DRX or DTX cycle of the network node, and wherein Layer 1 (L1) or Layer 2 (L2) information indicates a parameter of the plurality of parameters to be applied to the DRX or DTX cycle of the network node.

Aspect 68: The method of Aspect 67, wherein the L1 or L2 information is specific to a cell of a plurality of cells that transmit the L1 or L2 information.

Aspect 69: The method of Aspect 67, wherein the L1 or L2 information is configured to be applied by a plurality of cells that transmit the L1 or L2 information.

Aspect 70: The method of any of Aspects 57-69, further comprising receiving an indication of a plurality of resources to be used for monitoring for a random access response message after a random access channel Message 1 and during a random access response window, wherein one or more resources of the plurality of resources are within an inactive duration of the DRX or DTX cycle of the network node.

Aspect 71: The method of Aspect 70, further comprising receiving an indication to refrain from monitoring the one or more resources that are within the inactive duration of the DRX or DTX cycle of the network node, wherein the indication to refrain from monitoring the one or more resources that are within the inactive duration of the DRX or DTX cycle of the network node is included in a DRX or DTX cycle configuration or a physical downlink control channel message.

Aspect 72: The method of Aspect 71, further comprising refraining from monitoring the one or more resources that are within the inactive duration of the DRX or DTX cycle of the network node based at least in part on receiving the indication to refrain from monitoring the one or more resources that are within the inactive duration of the DRX or DTX cycle of the network node.

Aspect 73: The method of Aspect 71, further comprising receiving an indication of one or more rules for refraining from monitoring the one or more resources that are within the inactive duration of the DRX or DTX cycle of the network node.

Aspect 74: The method of any of Aspects 57-73, further comprising receiving an indication of a DRX or DTX cycle of a neighbor cell of the network node, wherein the neighbor cell is within a distance of the network node that is less than a distance threshold.

Aspect 75: The method of Aspect 74, wherein the DRX or DTX cycle of the neighbor cell is a common DRX or DTX cycle that is shared by the network node and the neighbor cell or by the neighbor cell and a serving cell.

Aspect 76: The method of Aspect 75, further comprising receiving an indication of one or more restrictions associated with the common DRX or DTX cycle, wherein the indication of the one or more restrictions indicates one or more cells that are to apply the one or more restrictions.

Aspect 77: The method of Aspect 75, further comprising receiving an indication of a plurality of cells that are configured with the common DRX or DTX cycle and an indication of one or more restrictions to be applied by the plurality of cells that are configured with the common DRX or DTX cycle.

Aspect 78: The method of any of Aspects 57-77, wherein the DRX or DTX cycle of the network node restricts one or more timers associated with the connected mode DRX or DTX cycle of the UE.

Aspect 79: The method of Aspect 78, further comprising refraining from communicating with the network node during an active duration of the connected mode DRX or DTX cycle of the UE based at least in part on the active duration of the connected mode DRX or DTX cycle of the UE overlapping with an inactive duration of the DRX or DTX cycle of the network node.

Aspect 80: The method of Aspect 78, wherein the DRX or DTX cycle of the network node indicates to change a timer value for the one or more timers to a default value or indicates a new value for the one or more timers.

Aspect 81: The method of any of Aspects 57-80, wherein the UE is configured with one or more default restrictions to be applied to the DRX or DTX cycle of the network node.

Aspect 82: The method of Aspect 81, wherein the one or more default restrictions to be applied to the DRX or DTX cycle of the network node are received via a broadcast transmission.

Aspect 83: A method of wireless communication performed by a network node, comprising: transmitting an indication of a discontinuous reception (DRX) or discontinuous transmission (DTX) cycle of the network node; and communicating with a user equipment (UE) based at least in part on switching between a connected mode DRX or DTX cycle of the UE and the DRX or DTX cycle of the network node.

Aspect 84: The method of Aspect 83, wherein only one of the connected mode DRX or DTX cycle of the UE, or the DRX or DTX cycle of the network node, is active at a particular time.

Aspect 85: The method of any of Aspects 83-84, wherein the DRX or DTX cycle of the network node is based at least in part on the connected mode DRX or DTX cycle of the UE.

Aspect 86: The method of Aspect 85, wherein the DRX or DTX cycle of the network node includes one or more rules, one or more timers, one or more downlink restrictions, one or more uplink restrictions, or one or more dynamic adaptation rules associated with the connected mode DRX or DTX cycle of the UE.

Aspect 87: The method of any of Aspects 83-86, further comprising transmitting Layer 1 or Layer 2 information that indicates for the UE to switch between the connected mode DRX or DTX cycle of the UE and the DRX or DTX cycle of the network node.

Aspect 88: The method of any of Aspects 83-87, wherein transmitting the indication of the DRX or DTX cycle of the network node comprises transmitting one or more of an offset, a duration, or a periodicity for the DRX or DTX cycle of the network node.

Aspect 89: The method of any of Aspects 83-88, wherein the network node is configured with one or more default values corresponding to an offset, a duration, or a periodicity for the DRX or DTX cycle of the network node.

Aspect 90: The method of any of Aspects 83-89, further comprising transmitting radio resource control configuration information that indicates a plurality of candidate restrictions and a plurality of candidate cells associated with the DRX or DTX cycle of the network node.

Aspect 91: The method of Aspect 90, wherein Layer 1 or Layer 2 information is used to indicate a restriction, from the plurality of candidate restrictions, to be applied to the DRX or DTX cycle of the network node, or to indicate a cell, of the plurality of candidate cells, for which the restriction is to be applied.

Aspect 92: The method of Aspect 91, wherein the restriction applies to one or more resources of a plurality of resources associated with the DRX or DTX cycle of the network node.

Aspect 93: The method of any of Aspects 83-92, further comprising transmitting radio resource control configuration information that indicates a plurality of parameters associated with the DRX or DTX cycle of the network node, and wherein Layer 1 (L1) or Layer 2 (L2) information indicates a parameter of the plurality of parameters to be applied to the DRX or DTX cycle of the network node.

Aspect 94: The method of Aspect 93, wherein the L1 or L2 information is specific to a cell of a plurality of cells that transmit the L1 or L2 information.

Aspect 95: The method of Aspect 93, wherein the L1 or L2 information is configured to be applied by a plurality of cells that transmit the L1 or L2 information.

Aspect 96: The method of any of Aspects 83-95, further comprising transmitting an indication of a plurality of resources to be used for monitoring for a random access response message after a random access channel Message 1 and during a random access response window, wherein one or more resources of the plurality of resources are within an inactive duration of the DRX or DTX cycle of the network node.

Aspect 97: The method of Aspect 96, further comprising transmitting an indication to refrain from monitoring the one or more resources that are within the inactive duration of the DRX or DTX cycle of the network node, wherein the indication to refrain from monitoring the one or more resources that are within the inactive duration of the DRX or DTX cycle of the network node is included in a DRX or DTX cycle configuration or a physical downlink control channel message.

Aspect 98: The method of Aspect 97, further comprising transmitting an indication of one or more rules for refraining from monitoring the one or more resources that are within the inactive duration of the DRX or DTX cycle of the network node.

Aspect 99: The method of any of Aspects 83-98, further comprising transmitting an indication of a DRX or DTX cycle of a neighbor cell, wherein the neighbor cell is within a distance of the network node that is less than a distance threshold.

Aspect 100: The method of Aspect 99, wherein the DRX or DTX cycle of the neighbor cell is a common DRX or DTX cycle that is shared by the network node and the neighbor cell or by the neighbor cell and a serving cell.

Aspect 101: The method of Aspect 100, further comprising transmitting an indication of one or more restrictions associated with the common DRX or DTX cycle, wherein the indication of the one or more restrictions indicates one or more cells that are to apply the one or more restrictions.

Aspect 102: The method of Aspect 100, further comprising transmitting an indication of a plurality of cells that are configured with the common DRX or DTX cycle and an indication of one or more restrictions to be applied by the plurality of cells that are configured with the common DRX or DTX cycle.

Aspect 103: The method of any of Aspects 83-102, wherein the network node is configured with one or more default restrictions to be applied to the DRX or DTX cycle of the network node.

Aspect 104: The method of Aspect 103, wherein the one or more default restrictions to be applied to the DRX or DTX cycle of the network node are received via a broadcast transmission.

Aspect 105: An apparatus for wireless communication at a device, comprising a processor; memory coupled with the processor; and instructions stored in the memory and executable by the processor to cause the apparatus to perform the method of one or more of Aspects 1-104.

Aspect 106: A device for wireless communication, comprising a memory and one or more processors coupled to the memory, the one or more processors configured to perform the method of one or more of Aspects 1-104.

Aspect 107: An apparatus for wireless communication, comprising at least one means for performing the method of one or more of Aspects 1-104.

Aspect 108: A non-transitory computer-readable medium storing code for wireless communication, the code comprising instructions executable by a processor to perform the method of one or more of Aspects 1-104.

Aspect 109: A non-transitory computer-readable medium storing a set of instructions for wireless communication, the set of instructions comprising one or more instructions that, when executed by one or more processors of a device, cause the device to perform the method of one or more of Aspects 1-104.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
one or more memories; and
one or more processors, coupled to the one or more memories, configured to cause the UE to:
receive a cell discontinuous reception (DRX) or discontinuous transmission (DTX) configuration indicating a periodicity for a cell DRX or DTX cycle, the periodicity being based on a period for a connected mode DRX or DTX cycle of the UE; and
communicate with a network node in accordance with the cell DRX or DTX cycle and the periodicity for the cell DRX or DTX cycle.

2. The UE of claim 1, wherein the periodicity is an integer multiple of a period for a connected mode DRX or DTX cycle of the UE.

3. The UE of claim 1, wherein a cell associated with the cell DRX or DTX configuration is included in a cell group configured with a plurality of DRX or DTX configurations.

4. The UE of claim 3, wherein the plurality of DRX or DTX configurations includes a first DRX or DTX configuration indicating a first DRX or DTX cycle and a second DRX or DTX configuration indicating a second DRX or DTX cycle, and
wherein one or more parameters of the first DRX or DTX cycle are different than one or more parameters of the second DRX or DTX cycle.

5. The UE of claim 3, wherein the plurality of DRX or DTX configurations includes a first DRX or DTX configuration indicating a first DRX or DTX cycle and a second DRX or DTX configuration indicating a second DRX or DTX cycle, and
wherein one or more parameters of the first DRX or DTX cycle are the same as one or more parameters of the second DRX or DTX cycle.

6. The UE of claim 1, wherein the one or more processors are further configured to cause the UE to:
receive an indication for activating the cell DRX or DTX configuration; and
wherein the one or more processors, to cause the UE to communicate with the network node in accordance with the cell DRX or DTX cycle and the periodicity for the cell DRX or DTX cycle, are configured to cause the UE to:
communicate with the network node in accordance with the cell DRX or DTX cycle and the periodicity for the cell DRX or DTX cycle based on receiving the indication.

7. The UE of claim 1, wherein the periodicity indicated in the cell DRX or DTX configuration is associated with a first cell and the cell DRX or DTX configuration indicates one or more parameters for another cell DRX or DTX configuration associated with a second cell that is different from the first cell.

8. A network node for wireless communication, comprising:
one or more memories; and
one or more processors, coupled to the one or more memories, configured to cause the network node to:
transmit a cell discontinuous reception (DRX) or discontinuous transmission (DTX) configuration indicating a periodicity for a cell DRX or DTX cycle, the periodicity being based on a period for a connected mode DRX or DTX cycle of a user equipment (UE); and
communicate with the UE in accordance with the cell DRX or DTX cycle and the periodicity for the cell DRX or DTX cycle.

9. The network node of claim 8, wherein the periodicity is an integer multiple of a period for a connected mode DRX or DTX cycle of the UE.

10. The network node of claim 8, wherein a cell associated with the cell DRX or DTX configuration is included in a cell group configured with a plurality of DRX or DTX configurations.

11. The network node of claim 10, wherein the plurality of DRX or DTX configurations includes a first DRX or DTX configuration indicating a first DRX or DTX cycle and a second DRX or DTX configuration indicating a second DRX or DTX cycle, and
wherein one or more parameters of the first DRX or DTX cycle are different than one or more parameters of the second DRX or DTX cycle.

12. The network node of claim 10, wherein the plurality of DRX or DTX configurations includes a first DRX or DTX configuration indicating a first DRX or DTX cycle and a second DRX or DTX configuration indicating a second DRX or DTX cycle, and
wherein one or more parameters of the first DRX or DTX cycle are the same as one or more parameters of the second DRX or DTX cycle.

13. The network node of claim 8, wherein the one or more processors are further configured to cause the network node to:
transmit an indication for activating the cell DRX or DTX configuration; and
wherein the one or more processors, to cause the network node to communicate with the UE in accordance with the cell DRX or DTX cycle and the periodicity for the cell DRX or DTX cycle, are configured to cause the network node to:
communicate with the UE in accordance with the cell DRX or DTX cycle and the periodicity for the cell DRX or DTX cycle based on receiving the indication.

14. The network node of claim 8, wherein the periodicity indicated in the cell DRX or DTX configuration is associated with a first cell and the cell DRX or DTX configuration indicates one or more parameters for a DRX or DTX configuration associated with a second cell that is different from the first cell.

15. A method of wireless communication performed by a user equipment (UE), comprising:
receiving a cell discontinuous reception (DRX) or discontinuous transmission (DTX) configuration indicating a periodicity for a cell DRX or DTX cycle, the periodicity being based on a period for a connected mode DRX or DTX cycle of the UE; and
communicating with a network node in accordance with the cell DRX or DTX cycle and the periodicity for the cell DRX or DTX cycle.

16. The method of claim 15, wherein the periodicity is an integer multiple of a period for a connected mode DRX or DTX cycle of the UE.

17. The method of claim 15, wherein a cell associated with the cell DRX or DTX configuration is included in a cell group configured with a plurality of DRX or DTX configurations.

18. The method of claim 17, wherein the plurality of DRX or DTX configurations includes a first DRX or DTX configuration indicating a first DRX or DTX cycle and a second DRX or DTX configuration indicating a second DRX or DTX cycle, and
wherein one or more parameters of the first DRX or DTX cycle are different than one or more parameters of the second DRX or DTX cycle.

19. The method of claim 17, wherein the plurality of DRX or DTX configurations includes a first DRX or DTX configuration indicating a first DRX or DTX cycle and a second DRX or DTX configuration indicating a second DRX or DTX cycle, and
wherein one or more parameters of the first DRX or DTX cycle are the same as one or more parameters of the second DRX or DTX cycle.

20. The method of claim 15, further comprising:
receiving an indication for activating the cell DRX or DTX configuration; and
wherein communicating with the network node in accordance with the cell DRX or DTX cycle and the periodicity for the cell DRX or DTX cycle comprises:
communicating with the network node in accordance with the cell DRX or DTX cycle and the periodicity for the cell DRX or DTX cycle based on receiving the indication.
